(19) United States
(12) Patent Application Publication
(10) Pub. No.: US 2018/0048894 A1
(43) Pub. Date: Feb. 15, 2018

(54) METHODS AND SYSTEMS OF PERFORMING LIGHTING CONDITION CHANGE COMPENSATION IN VIDEO ANALYTICS

(71) Applicant: QUALCOMM Incorporated, San Diego, CA (US)

(72) Inventors: Ying Chen, San Diego, CA (US); Lei Wang, Clovis, CA (US); Jian Wei, San Diego, CA (US)

(21) Appl. No.: 15/402,757

(22) Filed: Jan. 10, 2017

Related U.S. Application Data
(60) Provisional application No. 62/373,788, filed on Aug. 11, 2016.

(51) Int. Cl. H04N 19/142; H04N 19/176; H04N 19/182; H04N 19/172

(52) U.S. Cl. CPC H04N 19/142; H04N 19/172; H04N 19/176; H04N 19/182

(57) ABSTRACT

Techniques and systems are provided for processing video data. For example, techniques and systems are provided for compensating for lighting changes in one or more video frames. To perform the lighting change compensation, a current frame and a background picture are obtained. A frame-level lighting condition change is then detected for the current frame. A block-level comparison of the current frame and the background picture is performed when the frame-level lighting condition change is detected. The block-level comparison includes comparing a block of pixels of the current frame with a corresponding block of pixels of the background picture. Based on the block-level comparison, it is determined that a change in the block of the current frame relative to a previous frame is associated with a change in lighting. Blob-level lighting compensation can also be performed.

### CROSS-REFERENCE TO RELATED APPLICATIONS

This application claims the benefit of U.S. Provisional Application No. 62/373,788, filed Aug. 11, 2016, which is hereby incorporated by reference, in its entirety.

### FIELD

The present disclosure generally relates to video analytics, and more specifically to techniques and systems for compensating for lighting condition changes in video analytics.

### BACKGROUND

Many devices and systems allow a scene to be captured by generating video data of the scene. For example, an Internet protocol camera (IP camera) is a type of digital video camera that can be employed for surveillance or other applications. Unlike analog closed circuit television (CCTV) cameras, an IP camera can send and receive data via a computer network and the Internet. The video data from these devices and systems can be captured and output for processing and/or consumption.

Video analytics, also referred to as Video Content Analysis (VCA), is a generic term used to describe computerized processing and analysis of a video sequence acquired by a camera. Video analytics provides a variety of tasks, including immediate detection of events of interest, analysis of pre-recorded video for the purpose of extracting events in a long period of time, and many other tasks. For instance, using video analytics, a system can automatically analyze the video sequences from one or more cameras to detect one or more events. In some cases, video analytics can send alerts or alarms for certain events of interest. More advanced video analytics is needed to provide efficient and robust video sequence processing.

### BRIEF SUMMARY

In some embodiments, techniques and systems are described for compensating for lighting condition changes in video analytics. For example, lighting condition changes can be compensated for at a frame-level or at a blob-level for a sequence of video frames. A blob represents at least a portion of one or more objects in a video frame (also referred to herein as a picture). The frame-level and blob-level lighting condition change compensation techniques can be performed at different stages of a video analytics system. In an example video analytics system, background subtraction is applied to a frame (or picture) and a foreground-background binary mask (referred to herein as a foreground mask or a foreground-background mask) is generated for the picture. Morphology operations can be applied to the foreground mask to reduce noise present in the foreground mask. Once morphology operations are applied, connected component analysis can be performed to generate the blobs. The blobs can then be provided, for example, for blob processing, object tracking, and other video analytics functions. For example, during object tracking, blob trackers can be associated with blobs and can be output for tracking the blobs.

The background subtraction performed by video analytics allows foreground objects to be distinguished without a high amount of additional complexity. However, when the lighting conditions in a scene change either slightly or dramatically, the background subtraction results can become less consistent to the expectation in terms of detecting foreground objects due to the background model being unable to accommodate such lighting changes. For example, background objects may be detected as foreground objects due to the lighting change causing background pixels to appear as foreground pixels. In some examples, an entire frame can even be detected as foreground when a dramatic lighting condition change occurs.

The techniques and systems described herein allow frame-level and blob-level lighting condition change compensation in video analytics. The frame-level lighting condition change compensation can be performed during blob detection to modify the foreground mask generated during background subtraction. The blob-level lighting condition change compensation can be performed during the object tracking process, and can prevent blob trackers from being output when an associated blob is determined to be caused by a lighting change. The frame-level and blob-level lighting condition change compensation techniques may be performed jointly or independently.

According to at least one example, a method of compensating for lighting changes in one or more video frames is provided that includes obtaining a current frame and a background picture. The method further includes detecting a frame-level lighting condition change for the current frame, and performing a block-level comparison of the current frame and the background picture when the frame-level lighting condition change is detected. The block-level comparison includes comparing a block of pixels of the current frame with a corresponding block of pixels of the background picture, where a location of the block in the current frame is the same as a location of the corresponding block in the background picture. The method further includes determining, based on the block-level comparison, that a change in the block of the current frame relative to a previous frame is associated with a change in lighting.

In another example, an apparatus is provided that includes a memory configured to store video data and a processor. The processor is configured to and can obtain a current frame and a background picture. The processor is further configured to and can detect a frame-level lighting condition change for the current frame, and perform a block-level comparison of the current frame and the background picture when the frame-level lighting condition change is detected. The block-level comparison includes comparing a block of pixels of the current frame with a corresponding block of pixels of the background picture, where a location of the block in the current frame is the same as a location of the corresponding block in the background picture. The processor is further configured to and can determine, based on the block-level comparison, that a change in the block of the current frame relative to a previous frame is associated with a change in lighting.

In another example, a computer readable medium is provided having stored thereon instructions that when executed by a processor perform a method that includes: obtaining a current frame and a background picture; detecting a frame-level lighting condition change for the current frame; performing a block-level comparison of the current frame and the background picture when the frame-level lighting condition change is detected, the block-level comparison including comparing a block of pixels of the current frame with a corresponding block of pixels of the background picture, wherein a location of the block in the current frame is the same as a location of the corresponding block in the background picture; and determining, based on the block-level comparison, that a change in the block of the current frame relative to a previous frame is associated with a change in lighting.

In another example, an apparatus is provided that includes means for obtaining a current frame and a background picture. The apparatus further comprises means for detecting a frame-level lighting condition change for the current frame, and means for performing a block-level comparison of the current frame and the background picture when the frame-level lighting condition change is detected. The block-level comparison includes comparing a block of pixels of the current frame with a corresponding block of pixels of the background picture, where a location of the block in the current frame is the same as a location of the corresponding block in the background picture. The apparatus further comprises means for determining, based on the block-level comparison, that a change in the block of the current frame relative to a previous frame is associated with a change in lighting.

In some aspects, the methods, apparatuses, and computer readable medium described above further comprise: obtaining a subsequent frame and an additional background picture, wherein the subsequent frame is obtained later in time than the current frame; determining a frame-level lighting condition change is not present for the subsequent frame; and performing a blob-level comparison of the subsequent frame and the additional background picture when the frame-level lighting condition change is determined not to be present for the subsequent frame. A blob includes pixels of at least a portion of one or more foreground objects in a video frame. In some aspects, the methods, apparatuses, and computer readable medium described above further comprise: determining, based on the blob-level comparison, that a blob of the subsequent frame is associated with a change in lighting, wherein the blob includes pixels of at least a portion of a foreground object in the subsequent frame; and determining the blob is a background blob based on determining the change in the blob is associated with the change in lighting. In some aspects, the blob-level comparison includes comparing blobs of the subsequent frame with corresponding blobs of the additional background picture.

In some aspects, detecting the frame-level lighting condition change for the input frame includes: comparing a first histogram of the current frame to a second histogram of the background picture to determine a similarity between the first histogram and the second histogram; and detecting the frame-level lighting condition change when the similarity between the first histogram and the second histogram is less than a similarity threshold.

In some aspects, comparing the block of the current frame with the corresponding block of the background picture includes determining a correlation between the block of the current frame and the corresponding block of the background picture. In some aspects, determining, based on the block-level comparison, that the change in the block of the current frame is associated with the change in lighting includes determining the correlation between the block of the current frame and the corresponding block of the background picture is greater than a threshold.

In some aspects, the methods, apparatuses, and computer readable medium described above further comprise generating a block-level picture mask including a lighting value for each block. A first lighting value is assigned to blocks of the current frame that include changes associated with the change in lighting, a second lighting value is assigned to blocks of the current frame that are not associated with the change in lighting. For example, the first value for a first block of the current frame indicates a difference between the first block and a corresponding first block of the background picture is caused by the change in lighting, and the second value for a second block of the current frame indicates a difference between the second block and a corresponding second block of the background picture is not caused by the change in lighting.

In some aspects, the methods, apparatuses, and computer readable medium described above further comprise converting the block-level picture mask to a pixel-level picture mask, wherein converting includes mapping a respective lighting value for each block to all pixels in each block.

In some aspects, the methods, apparatuses, and computer readable medium described above further comprise: obtaining a foreground mask for the current frame; comparing the pixel-level picture mask to the foreground mask; and determining whether one or more foreground pixels of the foreground mask are to be maintained as foreground pixels based on the comparison of the pixel-level picture mask to the foreground mask, wherein a foreground pixel of the foreground mask is maintained as the foreground pixel when the second lighting value is assigned to the foreground pixel in the pixel-level picture mask.

In some aspects, the methods, apparatuses, and computer readable medium described above further comprise performing an erosion function on the block-level picture mask. The erosion function sets the first lighting value to the second lighting value for one or more blocks of the block-level picture mask.

In some aspects, the methods, apparatuses, and computer readable medium described above further comprise performing one or more dilation functions on the block-level picture mask. The one or more dilation functions set the second lighting value to the first lighting value for one or more blocks of the block-level picture mask.

In some aspects, the background picture includes corresponding mean values for each pixel location of the background picture.

In some aspects, a pixel value for a pixel location in the background picture is determined using a background model selected from a plurality of background models, and wherein the selected background model has a highest weight from among the plurality of background models.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present invention are described in detail below with reference to the following drawing figures:

FIG. 1 is a block diagram illustrating an example of a system including a video source and a video analytics system, in accordance with some embodiments.

FIG. 2 is an example of a video analytics system processing video frames, in accordance with some embodiments.

FIG. 3 is a block diagram illustrating an example of a blob detection engine, in accordance with some embodiments.

FIG. 4 is a block diagram illustrating an example of an object tracking engine, in accordance with some embodiments.

FIG. 5 is a block diagram illustrating an example of a blob detection engine including components for performing lighting condition change compensation, in accordance with some embodiments.

FIG. 6 is a flowchart illustrating an embodiment of a process of performing frame-level lighting condition change compensation, in accordance with some embodiments.

FIG. 7A illustrates an example of a frame that has been divided into a plurality of blocks, in accordance with some embodiments.

FIG. 7B illustrates an example of a background picture that has been divided into a plurality of blocks, in accordance with some embodiments.

FIG. 8 is a block diagram illustrating an example of a blob tracker update engine including components for performing blob-level lighting condition change compensation, in accordance with some embodiments.

FIG. 9 is a flowchart illustrating an embodiment of a process of performing blob-level lighting condition change compensation.

FIG. 10 is a flowchart illustrating an embodiment of a process of compensating for lighting changes in one or more video frames, in accordance with some embodiments.

FIG. 11A is an illustration of a video frame capturing a scene with lighting condition changes.

FIG. 11B is an illustration of another video frame capturing a scene with lighting condition changes.

FIG. 12A is an illustration of a video frame capturing a scene with lighting condition changes.

FIG. 12B is an illustration of another video frame capturing a scene with lighting condition changes.

FIG. 13 is an illustration of a video frame capturing a scene with lighting condition changes.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video analytics system can obtain a video sequence from a video source and can process the video sequence to provide a variety of tasks. One example of a video source can include an Internet protocol camera (IP camera), or other video capture device. An IP camera is a type of digital video camera that can be used for surveillance, home security, or other suitable application. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

An IP camera can be used to send and receive data via a computer network and the Internet. In some cases, IP camera systems can be used for two-way communications. For example, data (e.g., audio, video, metadata, or the like) can be transmitted by an IP camera using one or more network cables or using a wireless network, allowing users to communicate with what they are seeing. In one illustrative example, a gas station clerk can assist a customer with how to use a pay pump using video data provided from an IP camera (e.g., by viewing the customer's actions at the pay pump). Commands can also be transmitted for pan, tilt, zoom (PTZ) cameras via a single network or multiple networks. Furthermore, IP camera systems provide flexibility and wireless capabilities. For example, IP cameras provide for easy connection to a network, adjustable camera location, and remote accessibility to the service over Internet. IP camera systems also provide for distributed intelligence. For example, with IP cameras, video analytics can be placed in the camera itself. Encryption and authentication is also easily provided with IP cameras. For instance, IP cameras offer secure data transmission through already defined encryption and authentication methods for IP based applications. Even further, labor cost efficiency is increased with IP cameras. For example, video analytics can produce alarms for certain events, which reduces the labor cost in monitoring all cameras (based on the alarms) in a system.

Video analytics provides a variety of tasks ranging from immediate detection of events of interest, to analysis of pre-recorded video for the purpose of extracting events in a long period of time, as well as many other tasks. Various research studies and real-life experiences indicate that in a surveillance system, for example, a human operator typically cannot remain alert and attentive for more than 20 minutes, even when monitoring the pictures from one camera. When there are two or more cameras to monitor or as time goes beyond a certain period of time (e.g., 20 minutes), the operator's ability to monitor the video and effectively respond to events is significantly compromised. Video analytics can automatically analyze the video sequences from the cameras and send alarms for events of interest. This way, the human operator can monitor one or more scenes in a passive mode. Furthermore, video analytics can analyze a huge volume of recorded video and can extract specific video segments containing an event of interest.

Video analytics also provides various other features. For example, video analytics can operate as an Intelligent Video Motion Detector by detecting moving objects and by tracking moving objects. In some cases, the video analytics can generate and display a bounding box around a valid object. Video analytics can also act as an intrusion detector, a video counter (e.g., by counting people, objects, vehicles, or the like), a camera tamper detector, an object left detector, an object/asset removal detector, an asset protector, a loitering detector, and/or as a slip and fall detector. Video analytics can further be used to perform various types of recognition functions, such as face detection and recognition, license plate recognition, object recognition (e.g., bags, logos, body marks, or the like), or other recognition functions. In some cases, video analytics can be trained to recognize certain objects. Another function that can be performed by video analytics includes providing demographics for customer metrics (e.g., customer counts, gender, age, amount of time spent, and other suitable metrics). Video analytics can also perform video search (e.g., extracting basic activity for a given region) and video summary (e.g., extraction of the key movements). In some instances, event detection can be performed by video analytics, including detection of fire, smoke, fighting, crowd formation, or any other suitable even the video analytics is programmed to or learns to detect. A detector can trigger the detection of an event of interest and sends an alert or alarm to a central control room to alert a user of the event of interest.

As described below, video analytics can perform background subtraction to generate and detect foreground blobs that are then used for object/blob detection and tracking. When lighting condition changes occur, background subtraction results may become less consistent in terms of detecting foreground objects. Systems and methods are described herein for compensating for lighting condition changes at different stages of a video analytics system.

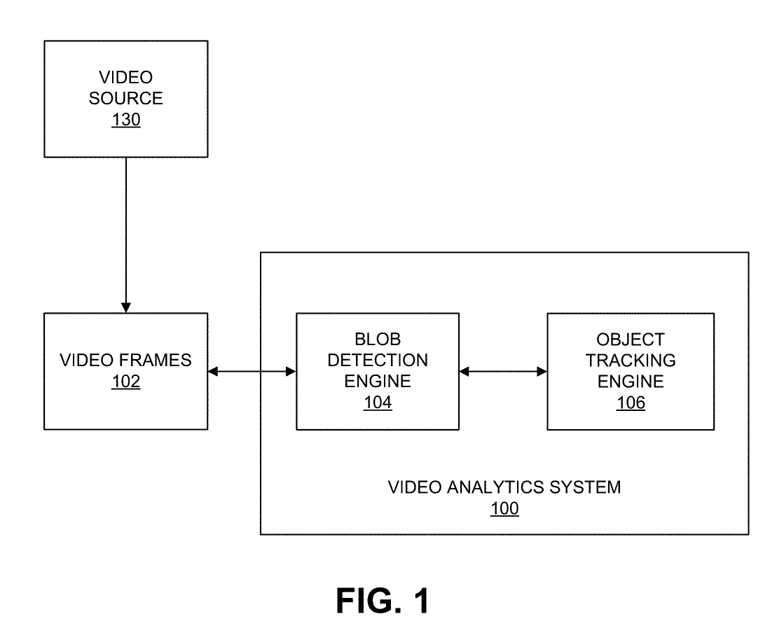

FIG. 1 is a block diagram illustrating an example of a video analytics system 100. The video analytics system 100 receives video frames 102 from a video source 130. The video frames 102 can also be referred to herein as a video picture or a picture. The video frames 102 can be part of one or more video sequences. The video source 130 can include a video capture device (e.g., a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 130 can include an IP camera or multiple IP cameras. In an illustrative example, multiple IP cameras can be located throughout an environment, and can provide the video frames 102 to the video analytics system 100. For instance, the IP cameras can be placed at various fields of view within the environment so that surveillance can be performed based on the captured video frames 102 of the environment.

In some embodiments, the video analytics system 100 and the video source 130 can be part of the same computing device. In some embodiments, the video analytics system 100 and the video source 130 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The video analytics system 100 includes a blob detection engine 104 and an object tracking engine 106. Object detection and tracking allows the video analytics system 100 to provide various end-to-end features, such as the video analytics features described above. For example, intelligent motion detection, intrusion detection, and other features can directly use the results from object detection and tracking to generate end-to-end events. Other features, such as people, vehicle, or other object counting and classification can be greatly simplified based on the results of object detection and tracking. The blob detection engine 104 can detect one or more blobs in video frames (e.g., video frames 102) of a video sequence, and the object tracking engine 106 can track the one or more blobs across the frames of the video sequence. As used herein, a blob refers to pixels of at least a portion of an object in a video frame. For example, a blob can include a contiguous group of pixels making up at least a portion of a foreground object in a video frame. In another example, a blob can refer to a contiguous group of pixels making up at least a portion of a background object in a frame of image data. A blob can also be referred to as an object, a portion of an object, a blotch of pixels, a pixel patch, a cluster of pixels, a blot of pixels, a spot of pixels, a mass of pixels, or any other term referring to a group of pixels of an object or portion thereof In some examples, a bounding box can be associated with a blob. In some examples, a tracker can also be represented by a tracker bounding box. In the tracking layer, in case there is no need to know how the blob is formulated within a bounding box, the term blob and bounding box may be used interchangeably.

As described in more detail below, blobs can be tracked using blob trackers. A blob tracker can be associated with a tracker bounding box and can be assigned a tracker identifier (ID). In some examples, a bounding box for a blob tracker in a current frame can be the bounding box of a previous blob in a previous frame for which the blob tracker was associated. For instance, when the blob tracker is updated in the previous frame (after being associated with the previous blob in the previous frame), updated information for the blob tracker can include the tracking information for the previous frame and also prediction of a location of the blob tracker in the next frame (which is the current frame in this example). The prediction of the location of the blob tracker in the current frame can be based on the location of the blob in the previous frame. A history or motion model can be maintained for a blob tracker, including a history of various states, a history of the velocity, and a history of location, of continuous frames, for the blob tracker, as described in more detail below.

In some examples, a motion model for a blob tracker can determine and maintain two locations of the blob tracker for each frame. For example, a first location for a blob tracker for a current frame can include a predicted location in the current frame. The first location is referred to herein as the predicted location. The predicted location of the blob tracker in the current frame includes a location in a previous frame of a blob with which the blob tracker was associated. Hence, the location of the blob associated with the blob tracker in the previous frame can be used as the predicted location of the blob tracker in the current frame. A second location for the blob tracker for the current frame can include a location in the current frame of a blob with which the tracker is associated in the current frame. The second location is referred to herein as the actual location. Accordingly, the location in the current frame of a blob associated with the blob tracker is used as the actual location of the blob tracker in the current frame. The actual location of the blob tracker in the current frame can be used as the predicted location of the blob tracker in a next frame. The location of the blobs can include the locations of the bounding boxes of the blobs.

The velocity of a blob tracker can include the displacement of a blob tracker between consecutive frames. For example, the displacement can be determined between the centers (or centroids) of two bounding boxes for the blob tracker in two consecutive frames. In one illustrative example, the velocity of a blob tracker can be defined as Vₜ=Cₜ−Cₜ₋₁, where Cₜ−Cₜ₋₁=(Cₜₓ−Cₜ₋₁ₓ, C_{ty}−C_{t-1y}). The term Cₜ(Cₜₓ, C_{ty}) denotes the center position of a bounding box of the tracker in a current frame, with Cₜₓ being the x-coordinate of the bounding box, and C_{ty} being the y-coordinate of the bounding box. The term Cₜ₋₁(C_{t-1x,}C_{t-1y}) denotes the center position (x and y) of a bounding box of the tracker in a previous frame. In some implementations, it is also possible to use four parameters to estimate x, y, width, height at the same time. In some cases, because the timing for video frame data is constant or at least not dramatically different overtime (according to the frame rate, such as 30 frames per second, 60 frames per second, 120 frames per second, or other suitable frame rate), a time variable may not be needed in the velocity calculation. In some cases, a time constant can be used (according to the instant frame rate) and/or a timestamp can be used.

Using the blob detection engine 104 and the object tracking engine 106, the video analytics system 100 can perform blob generation and detection for each frame or picture of a video sequence. For example, the blob detection engine 104 can perform background subtraction for a frame, and can then detect foreground pixels in the frame. Foreground blobs are generated from the foreground pixels using morphology operations and spatial analysis.

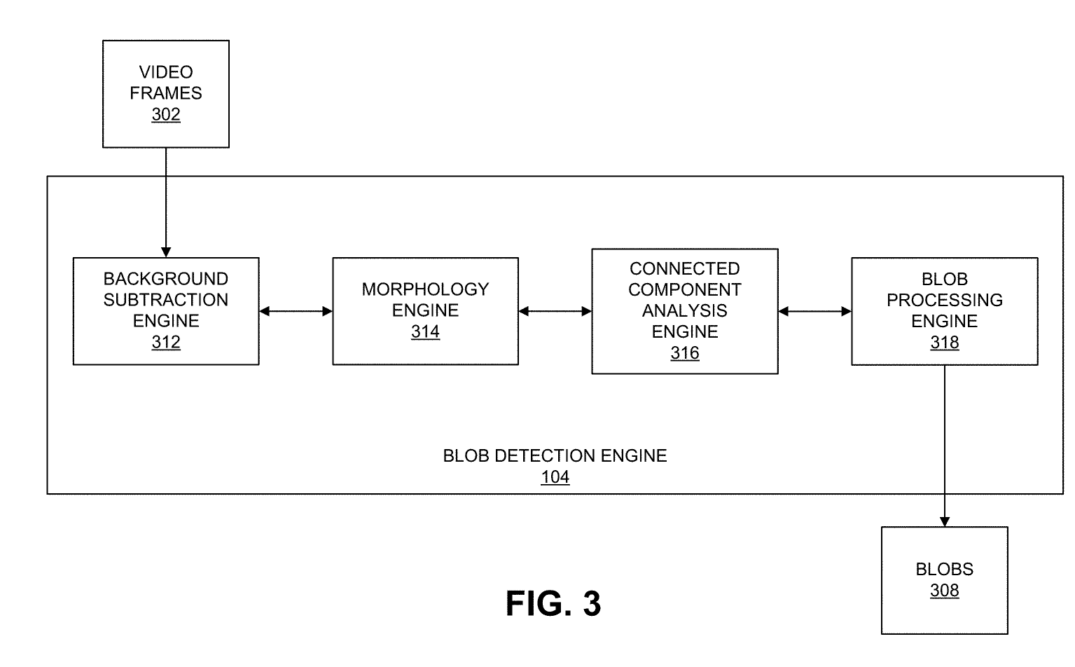

Further, blob trackers from previous frames need to be associated with the foreground blobs in a current frame, and also need to be updated. Both the data association of trackers with blobs and tracker updates can rely on a cost function calculation. For example, when blobs are detected from a current input video frame, the blob trackers from the previous frame can be associated with the detected blobs according to a cost calculation. Trackers are then updated according to the data association, including updating the state and location of the trackers so that tracking of objects in the current frame can be fulfilled. Further details related to the blob detection engine 104 and the object tracking engine 106 are described with respect to FIGS. 3, 4, 5, and 8.

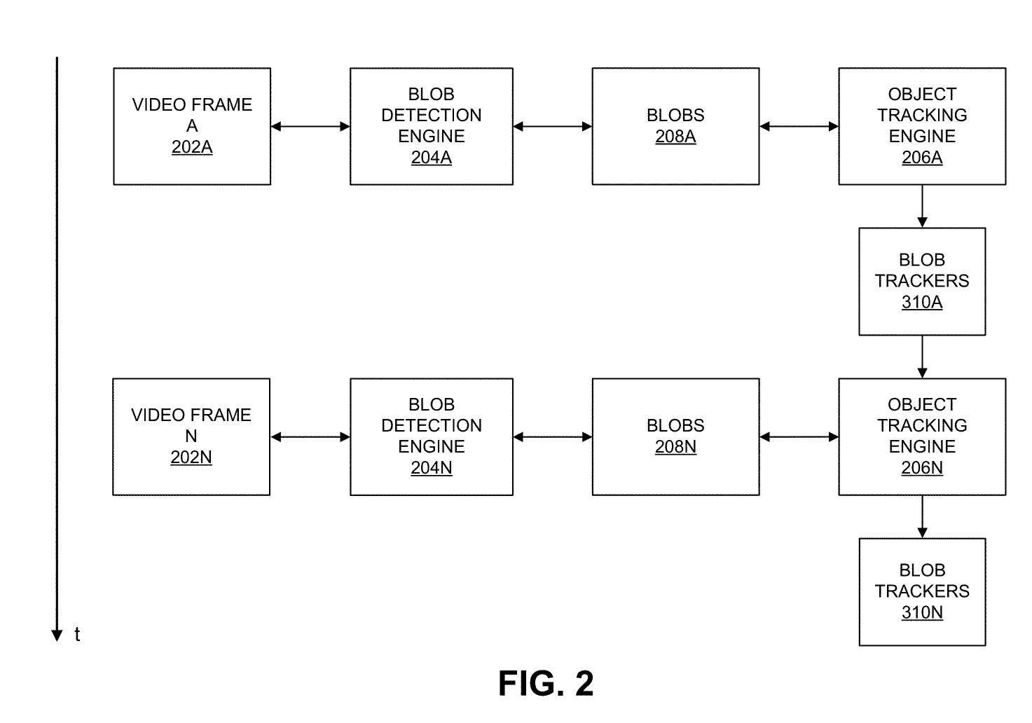

FIG. 2 is an example of the video analytics system (e.g., video analytics system 100) processing video frames across time t. As shown in FIG. 2, a video frame A 202A is received by a blob detection engine 204A. The blob detection engine 204A generates foreground blobs 208A for the current frame A 202A. After blob detection is performed, the foreground blobs 208A can be used for temporal tracking by the object tracking engine 206A. Costs (e.g., a cost including a distance, a weighted distance, or other cost) between blob trackers and blobs can be calculated by the object tracking engine 206A. The object tracking engine 206A can perform data association to associate or match the blob trackers (e.g., blob trackers generated or updated based on a previous frame or newly generated blob trackers) and blobs 208A using the calculated costs (e.g., using a cost matrix or other suitable association technique). The blob trackers can be updated, including in terms of positions of the trackers, according to the data association to generate updated blob trackers 310A. For example, a blob tracker's state and location for the video frame A 202A can be calculated and updated. The blob tracker's location in a next video frame N 202N can also be predicted from the current video frame A 202A. For example, the predicted location of a blob tracker for the next video frame N 202N can include the location of the blob tracker (and its associated blob) in the current video frame A 202A. Tracking of blobs of the current frame A 202A can be performed once the updated blob trackers 310A are generated.

When a next video frame N 202N is received, the blob detection engine 204N generates foreground blobs 208N for the frame N 202N. The object tracking engine 206N can then perform temporal tracking of the blobs 208N. For example, the object tracking engine 206N obtains the blob trackers 310A that were updated based on the prior video frame A 202A. The object tracking engine 206N can then calculate a cost and can associate the blob trackers 310A and the blobs 208N using the newly calculated cost. The blob trackers 310A can be updated according to the data association to generate updated blob trackers 310N.

FIG. 3 is a block diagram illustrating an example of a blob detection engine 104. Blob detection is used to segment moving objects from the global background in a scene. The blob detection engine 104 includes a background subtraction engine 312 that receives video frames 302. The background subtraction engine 312 can perform background subtraction to detect foreground pixels in one or more of the video frames 302. For example, the background subtraction can be used to segment moving objects from the global background in a video sequence and to generate a foreground-background binary mask (referred to herein as a foreground mask). In some examples, the background subtraction can perform a subtraction between a current frame or picture and a background model including the background part of a scene (e.g., the static or mostly static part of the scene). Based on the results of background subtraction, the morphology engine 314 and connected component analysis engine 316 can perform foreground pixel processing to group the foreground pixels into foreground blobs for tracking purpose. For example, after background subtraction, morphology operations can be applied to remove noisy pixels as well as to smooth the foreground mask. Connected component analysis can then be applied to generate the blobs. Blob processing can then be performed, which may include further filtering out some blobs and merging together some blobs to provide bounding boxes as input for tracking.

The background subtraction engine 312 can model the background of a scene (e.g., captured in the video sequence) using any suitable background subtraction technique (also referred to as background extraction). One example of a background subtraction method used by the background subtraction engine 312 includes modeling the background of the scene as a statistical model based on the relatively static pixels in previous frames which are not considered to belong to any moving region. For example, the background subtraction engine 312 can use a Gaussian distribution model for each pixel location, with parameters of mean and variance to model each pixel location in frames of a video sequence. All the values of previous pixels at a particular pixel location are used to calculate the mean and variance of the target Gaussian model for the pixel location. When a pixel at a given location in a new video frame is processed, its value will be evaluated by the current Gaussian distribution of this pixel location. A classification of the pixel to either a foreground pixel or a background pixel is done by comparing the difference between the pixel value and the mean of the designated Gaussian model. In one illustrative example, if the distance of the pixel value and the Gaussian Mean is less than 3 times of the variance, the pixel is classified as a background pixel. Otherwise, in this illustrative example, the pixel is classified as a foreground pixel. At the same time, the Gaussian model for a pixel location will be updated by taking into consideration the current pixel value.

The background subtraction engine 312 can also perform background subtraction using a mixture of Gaussians (GMM). A GMM models each pixel as a mixture of Gaussians and uses an online learning algorithm to update the model. Each Gaussian model is represented with mean, standard deviation (or covariance matrix if the pixel has multiple channels), and weight. Weight represents the probability that the Gaussian occurs in the past history.

$$P ( {X}_{t} ) = {\sum }_{i = 1}^{K} {ω}_{i , t} N ( {X}_{t} \vert {μ}_{i , t} , {Σ}_{i , t} ) \qquad Equation ( 1 )$$

An equation of the GMM model is shown in equation (1), wherein there are K Gaussian models. Each Gaussian model has a distribution with a mean of μ and variance of Σ, and has a weight ω. Here, i is the index to the Gaussian model and t is the time instance. As shown by the equation, the parameters of the GMM change over time after one frame (at time t) is processed.

The background subtraction techniques mentioned above are based on the assumption that the camera is mounted still, and if anytime the camera is moved or orientation of the camera is changed, a new background model will need to be calculated. There are also background subtraction methods that can handle foreground subtraction based on a moving background, including techniques such as tracking key points, optical flow, saliency, and other motion estimation based approaches.

The background subtraction engine 312 can generate a foreground mask with foreground pixels based on the result of background subtraction. For example, the foreground mask can include a binary image containing the pixels making up the foreground objects (e.g., moving objects) in a scene and the pixels of the background. In some examples, the background of the foreground mask (background pixels) can be a solid color, such as a solid white background, a solid black background, or other solid color. In such examples, the foreground pixels of the foreground mask can be a different color than that used for the background pixels, such as a solid black color, a solid white color, or other solid color. In one illustrative example, the background pixels can be black (e.g., pixel color value 0 in 8-bit grayscale or other suitable value) and the foreground pixels can be white (e.g., pixel color value 255 in 8-bit grayscale or other suitable value). In another illustrative example, the background pixels can be white and the foreground pixels can be black.

Using the foreground mask generated from background subtraction, a morphology engine 314 can perform morphology functions to filter the foreground pixels. The morphology functions can include erosion and dilation functions. In one example, an erosion function can be applied, followed by a series of one or more dilation functions. An erosion function can be applied to remove pixels on object boundaries. For example, the morphology engine 314 can apply an erosion function (e.g., FilterErode3×3) to a 3×3 filter window of a center pixel, which is currently being processed. The 3×3 window can be applied to each foreground pixel (as the center pixel) in the foreground mask. One of ordinary skill in the art will appreciate that other window sizes can be used other than a 3×3 window. The erosion function can include an erosion operation that sets a current foreground pixel in the foreground mask (acting as the center pixel) to a background pixel if one or more of its neighboring pixels within the 3×3 window are background pixels. Such an erosion operation can be referred to as a strong erosion operation or a single-neighbor erosion operation. Here, the neighboring pixels of the current center pixel include the eight pixels in the 3×3 window, with the ninth pixel being the current center pixel.

A dilation operation can be used to enhance the boundary of a foreground object. For example, the morphology engine 314 can apply a dilation function (e.g., FilterDilate3×3) to a 3×3 filter window of a center pixel. The 3×3 dilation window can be applied to each background pixel (as the center pixel) in the foreground mask. One of ordinary skill in the art will appreciate that other window sizes can be used other than a 3×3 window. The dilation function can include a dilation operation that sets a current background pixel in the foreground mask (acting as the center pixel) as a foreground pixel if one or more of its neighboring pixels in the 3×3 window are foreground pixels. The neighboring pixels of the current center pixel include the eight pixels in the 3×3 window, with the ninth pixel being the current center pixel. In some examples, multiple dilation functions can be applied after an erosion function is applied. In one illustrative example, three function calls of dilation of 3×3 window size can be applied to the foreground mask before it is sent to the connected component analysis engine 316. In some examples, an erosion function can be applied first to remove noise pixels, and a series of dilation functions can then be applied to refine the foreground pixels. In one illustrative example, one erosion function with 3x3 window size is called first, and three function calls of dilation of 3×3 window size are applied to the foreground mask before it is sent to the connected component analysis engine 316. Details regarding content-adaptive morphology operations are described below.

After the morphology operations are performed, the connected component analysis engine 316 can apply connected component analysis to connect neighboring foreground pixels to formulate connected components and blobs. One example of the connected component analysis performed by the connected component analysis engine 316 is implemented as follows:

for each pixel of the foreground mask {
if it is a foreground pixel and has not been processed, the following steps apply:
   Apply FloodFill function to connect this pixel to other foreground and generate a connected component
   Insert the connected component in a list of connected components.
   Mark the pixels in the connected component as being processed }

The Floodfill (seed fill) function is an algorithm that determines the area connected to a seed node in a multi-dimensional array (e.g., a 2-D image in this case). This Floodfill function first obtains the color or intensity value at the seed position (e.g., a foreground pixel) of the source foreground mask, and then finds all the neighbor pixels that have the same (or similar) value based on 4 or 8 connectivity. For example, in a 4 connectivity case, a current pixel's neighbors are defined as those with a coordination being (x+d, y) or (x, y+d), wherein d is equal to 1 or -1 and (x, y) is the current pixel. One of ordinary skill in the art will appreciate that other amounts of connectivity can be used. Some objects are separated into different connected components and some objects are grouped into the same connected components (e.g., neighbor pixels with the same or similar values). Additional processing may be applied to further process the connected components for grouping. Finally, the blobs 308 are generated that include neighboring foreground pixels according to the connected components. In one example, a blob can be made up of one connected component. In another example, a blob can include multiple connected components (e.g., when two or more blobs are merged together).

The blob processing engine 318 can perform additional processing to further process the blobs generated by the connected component analysis engine 316. In some examples, the blob processing engine 318 can generate the bounding boxes to represent the detected blobs and blob trackers. In some cases, the blob bounding boxes can be output from the blob detection engine 104. In some examples, the blob processing engine 318 can perform content-based filtering of certain blobs. For instance, a machine learning method can determine that a current blob contains noise (e.g., foliage in a scene). Using the machine learning information, the blob processing engine 318 can determine the current blob is a noisy blob and can remove it from the resulting blobs that are provided to the object tracking engine 106. In some examples, the blob processing engine 318 can merge close blobs into one big blob to remove the risk of having too many small blobs that could belong to one object. In some examples, the blob processing engine 318 can filter out one or more small blobs that are below a certain size threshold (e.g., an area of a bounding box surrounding a blob is below an area threshold). In some embodiments, the blob detection engine 104 does not include the blob processing engine 318, or does not use the blob processing engine 318 in some instances. For example, the blobs generated by the connected component analysis engine 316, without further processing, can be input to the object tracking engine 106 to perform blob and/or object tracking.

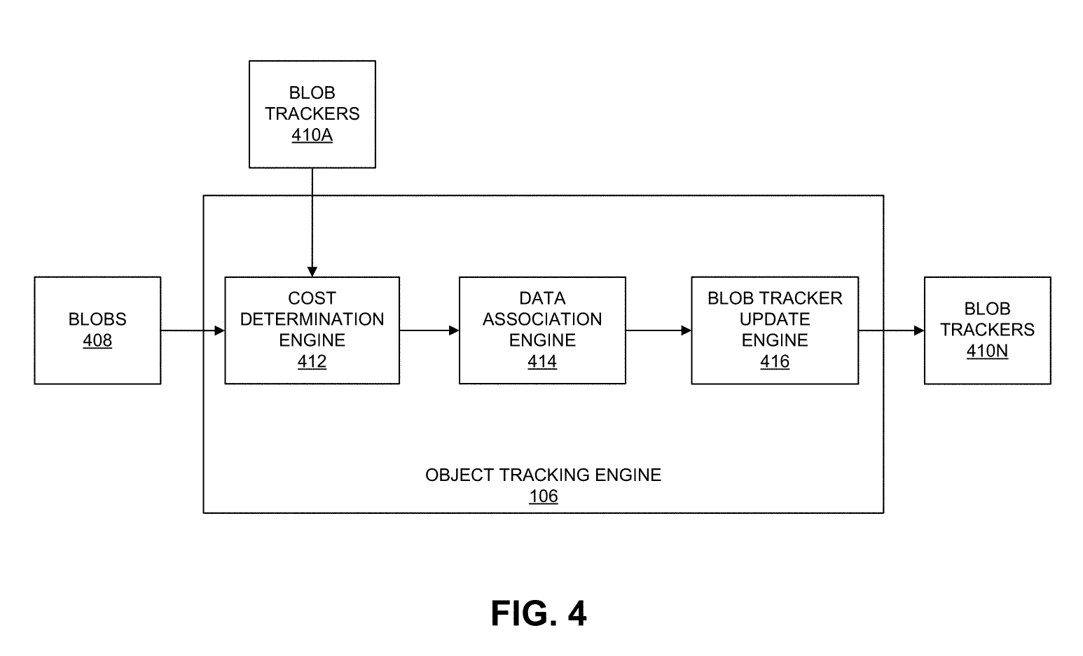

FIG. 4 is a block diagram illustrating an example of an object tracking engine 106. Object tracking in a video sequence can be used for many applications, including surveillance applications, among many others. For example, the ability to detect and track multiple objects in the same scene is of great interest in many security applications. When blobs (making up at least portions of objects) are detected from an input video frame, blob trackers from the previous video frame need to be associated to the blobs in the input video frame according to a cost calculation. The blob trackers can be updated based on the associated foreground blobs. In some instances, the steps in object tracking can be conducted in a series manner.

A cost determination engine 412 of the object tracking engine 106 can obtain the blobs 408 of a current video frame from the blob detection engine 104. The cost determination engine 412 can also obtain the blob trackers 410A updated from the previous video frame (e.g., video frame A 202A). A cost function can then be used to calculate costs between the object trackers 410A and the blobs 408. Any suitable cost function can be used to calculate the costs. In some examples, the cost determination engine 412 can measure the cost between a blob tracker and a blob by calculating the Euclidean distance between the centroid of the tracker (e.g., the bounding box for the tracker) and the centroid of the bounding box of the foreground blob. In one illustrative example using a 2-D video sequence, this type of cost function is calculated as below:

Cost_{tb}=\sqrt{(tₓ−bₓ)²+(t_{y}−b_{y})²}

The terms (tₓ, t_{y}) and (bₓ, b_{y}) are the center locations of the blob tracker and blob bounding boxes, respectively. As noted herein, in some examples, the bounding box of the blob tracker can be the bounding box of a blob associated with the blob tracker in a previous frame. In some examples, other cost function approaches can be performed that use a minimum distance in an x-direction or y-direction to calculate the cost. Such techniques can be good for certain controlled scenarios, such as well-aligned lane conveying. In some examples, a cost function can be based on a distance of a blob tracker and a blob, where instead of using the center position of the bounding boxes of blob and tracker to calculate distance, the boundaries of the bounding boxes are considered so that a negative distance is introduced when two bounding boxes are overlapped geometrically. In addition, the value of such a distance is further adjusted according to the size ratio of the two associated bounding boxes. For example, a cost can be weighted based on a ratio between the area of the blob tracker bounding box and the area of the blob bounding box (e.g., by multiplying the determined distance by the ratio).

In some embodiments, a cost is determined for each tracker-blob pair between each tracker and each blob. For example, if there are three trackers, including tracker A, tracker B, and tracker C, and three blobs, including blob A, blob B, and blob C, a separate cost between tracker A and each of the blobs A, B, and C can be determined, as well as separate costs between trackers B and C and each of the blobs A, B, and C. In some examples, the costs can be arranged in a cost matrix, which can be used for data association. For example, the cost matrix can be a 2-dimensional matrix, with one dimension being the blob trackers 410A and the second dimension being the blobs 408. Every tracker-blob pair or combination between the trackers 410A and the blobs 408 includes a cost that is included in the cost matrix. Best matches between the trackers 410A and blobs 408 can be determined by identifying the lowest cost tracker-blob pairs in the matrix. For example, the lowest cost between tracker A and the blobs A, B, and C is used to determine the blob with which to associate the tracker A.

Data association between trackers 410A and blobs 408, as well as updating of the trackers 410A, may be based on the determined costs. The data association engine 414 matches or assigns a tracker with a corresponding blob and vice versa. For example, as described previously, the lowest cost tracker-blob pairs may be used by the data association engine 414 to associate the blob trackers 410A with the blobs 408. Another technique for associating blob trackers with blobs includes the Hungarian method, which is a combinatorial optimization algorithm that solves such an assignment problem in polynomial time and that anticipated later primal-dual methods. For example, the Hungarian method can optimize a global cost across all blob trackers 410A with the blobs 408 in order to minimize the global cost. The blob tracker-blob combinations in the cost matrix that minimize the global cost can be determined and used as the association.

In addition to the Hungarian method, other robust methods can be used to perform data association between blobs and blob trackers. For example, the association problem can be solved with additional constraints to make the solution more robust to noise while matching as many trackers and blobs as possible.

Regardless of the association technique that is used, the data association engine 414 can rely on the distance between the blobs and trackers. The location of the foreground blobs are identified with the blob detection engine 104. However, a blob tracker location in a current frame may need to be predicted from a previous frame (e.g., using a location of a blob associated with the blob tracker in the previous frame). The calculated distance between the identified blobs and estimated trackers is used for data association. After the data association for the current frame, the tracker location in the current frame can be identified with the location of its associated blob(s) in the current frame. The tracker's location can be further used to update the tracker's motion model and predict its location in the next frame.

Once the association between the blob trackers 410A and blobs 408 has been completed, the blob tracker update engine 416 can use the information of the associated blobs, as well as the trackers' temporal statuses, to update the states of the trackers 410A for the current frame. Upon updating the trackers 410A, the blob tracker update engine 416 can perform object tracking using the updated trackers 410N, and can also provide the updated trackers 410N for use for a next frame.

The state of a blob tracker can include the tracker's identified location (or actual location) in a current frame and its predicted location in the next frame. The state can also, or alternatively, include a tracker's temporal status. The temporal status can include whether the tracker is a new tracker that was not present before the current frame, whether the tracker has been alive for certain frames, or other suitable temporal status. Other states can include, additionally or alternatively, whether the tracker is considered as lost when it does not associate with any foreground blob in the current frame, whether the tracker is considered as a dead tracker if it fails to associate with any blobs for a certain number of consecutive frames (e.g., 2 or more), or other suitable tracker states.

One method for performing a tracker location update is using a Kalman filter. The Kalman filter is a framework that includes two steps. The first step is to predict a tracker's state, and the second step is to use measurements to correct or update the state. In this case, the tracker from the last frame predicts (using the blob tracker update engine 416) its location in the current frame, and when the current frame is received, the tracker first uses the measurement of the blob(s) to correct its location states and then predicts its location in the next frame. For example, a blob tracker can employ a Kalman filter to measure its trajectory as well as predict its future location(s). The Kalman filter relies on the measurement of the associated blob(s) to correct the motion model for the blob tracker and to predict the location of the object tracker in the next frame. In some examples, if a blob tracker is associated with a blob in a current frame, the location of the blob is directly used to correct the blob tracker's motion model in the Kalman filter. In some examples, if a blob tracker is not associated with any blob in a current frame, the blob tracker's location in the current frame is identified as its predicted location from the previous frame, meaning that the motion model for the blob tracker is not corrected and the prediction propagates with the blob tracker's last model (from the previous frame).

Other than the location of a tracker, there may be other status information needed for updating the tracker, which may require a state machine for object tracking. Given the information of the associated blob(s) and the tracker's own status history table, the status also needs to be updated. The state machine collects all the necessary information and updates the status accordingly. Various statuses can be updated. For example, other than a tracker's life status (e.g., new, lost, dead, or other suitable life status), the tracker's association confidence and relationship with other trackers can also be updated. Taking one example of the tracker relationship, when two objects (e.g., persons, vehicles, or other objects of interest) intersect, the two trackers associated with the two objects will be merged together for certain frames, and the merge or occlusion status needs to be recorded for high level video analytics.

Regardless of the tracking method being used, a new tracker starts to be associated with a blob in one frame and, moving forward, the new tracker may be connected with possibly moving blobs across multiple frames. When a tracker has been continuously associated with blobs and a duration has passed, the tracker may be promoted to be a normal tracker and output as an identified tracker-blob pair. A tracker-blob pair is output at the system level as an event (e.g., presented as a tracked object on a display, output as an alert, or other suitable event) when the tracker is promoted to be a normal tracker. In some implementations, a normal tracker (e.g., including certain status data of the normal tracker, the motion model for the normal tracker, or other information related to the normal tracker) can be output as part of object metadata. The metadata, including the normal tracker, can be output from the video analytics system (e.g., an IP camera running the video analytics system) to a server or other system storage. The metadata can then be analyzed for event detection (e.g., by rule interpreter). A tracker that is not promoted as a normal tracker can be removed (or killed), after which the tracker can be considered as dead.

As previously described, the blob detection engine 104 can perform background subtraction to generate a foreground mask for a current frame, and can perform morphology operations to reduce noise present in the foreground mask. After morphology operations are applied, connected component analysis can be performed to generate connected components. After background subtraction and connected component analysis, foreground blobs may be identified for objects in the current frame. However, when the lighting conditions in a scene change either slightly or dramatically, the background subtraction results can become less consistent in terms of detecting foreground objects because the background model is unable to accommodate such lighting changes.

Lighting condition changes can cause the failure of both blob detection and blob tracking. For example, a dramatic lighting condition change that effects a large portion of a frame may lead to a large region (even the whole frame in some cases) becoming detected as foreground. In such instances, the background subtraction model loses the capability to identify any foreground objects. Even with slight lighting changes, an object may have totally different color information when compared to the original background model of the relevant pixels (e.g., indicating mean values for the pixel locations before the lighting change). When color information of a background object changes, the background object can become quite different and can thus be identified as a foreground object (due to the change in pixel values), leading to the potential of many false positives being detected.

While ignoring the background subtraction results for a frame that experiences a lighting condition change may prevent identification of a background object as foreground, it is not possible to ignore the background subtraction results and stop identifying the foreground objects since a lot of real foreground objects would not be detected. Such a solution would be detrimental, for example, because important events that should be detected would be missed. In one illustrative example, a thief breaking in through a window that has a curtain may not be detected due to light coming through the window when the curtain is moved.

Methods for correcting lighting condition changes required for background subtraction also cannot always be turned on, since it might aggressively diminish the foreground pixels and thus lead to a large loss in detection rate for real objects when the lighting condition change is not obvious or not present. For example, due to the aggressive nature of lighting condition change solutions, foreground pixels may unnecessarily be changed to background pixels.

Systems and methods are described herein for compensating for lighting condition changes. A unified solution is provided that accommodates perfect lighting condition (with no lighting condition change), slight lighting condition changes, and dramatic lighting condition changes. For example, lighting condition changes can be compensated for at a frame-level or at a blob-level for a sequence of video frames capturing a scene. As described in more detail below, frame-level lighting condition change compensation can be performed during blob detection to modify the foreground mask generated during background subtraction. The blob-level lighting condition change compensation can be performed during the object tracking process to prevent blob trackers from being output when an associated blob is determined to be caused by a lighting change. The frame-level and blob-level lighting condition change compensation techniques can be performed jointly or independently.

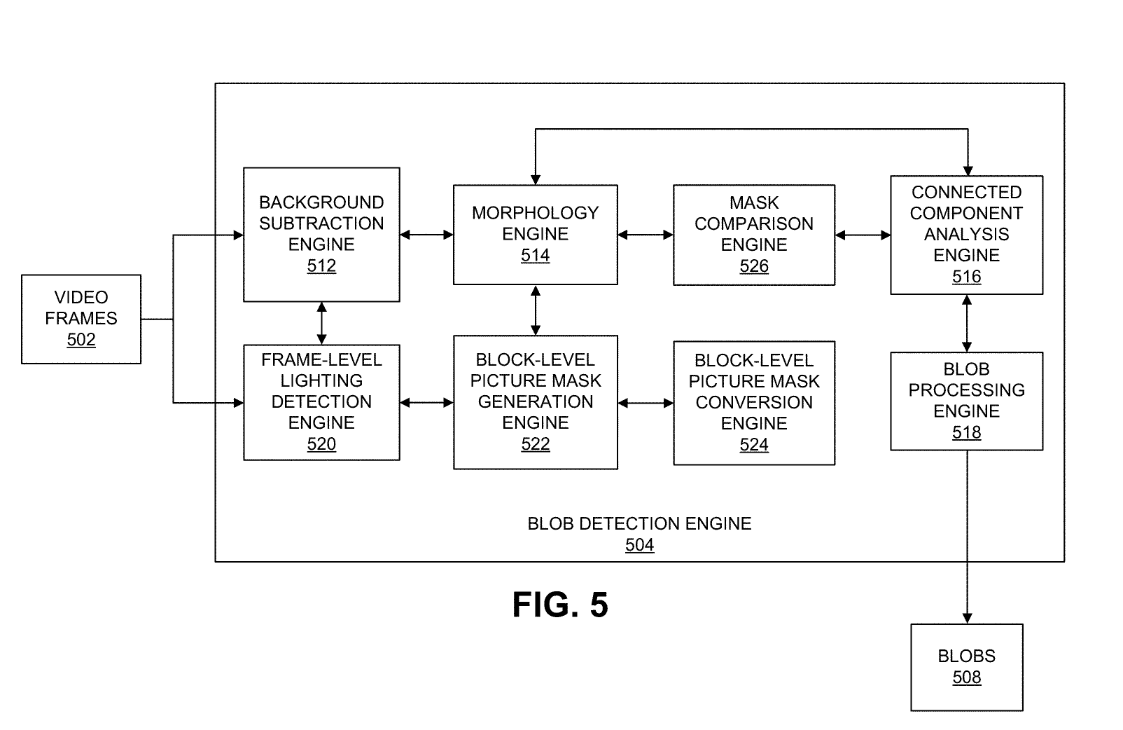

FIG. 5 is a block diagram illustrating an example of a blob detection engine 504 including components for performing frame-level lighting condition change compensation. Similar to the blob detection engine 104 described above, the blob detection engine 504 includes a background subtraction engine 512, a morphology engine 514, a connected component analysis engine 516, and a blob processing engine 518, which can be similar to and perform similar operations as the corresponding engines of the blob detection engine 104. The blob detection engine 504 also includes a frame-level lighting detection engine 520, a block-level picture mask generation engine 522, a block-level picture mask conversion engine 524, and a mask comparison engine 526.

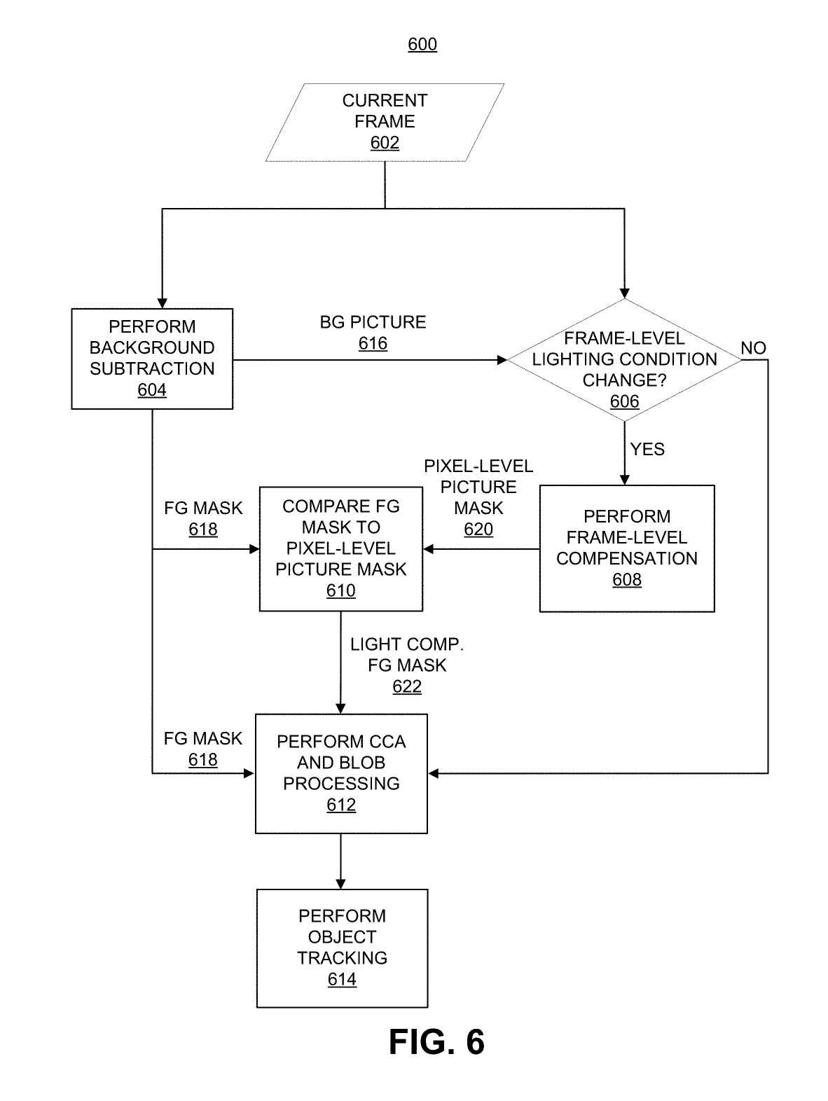

FIG. 6 is a flowchart illustrating an example of a process 600 of performing frame-level lighting condition change compensation, which will be described with respect to the components of the blob detection engine 504. A current frame 602 is provided as input to the background subtraction engine 512 and to the frame-level lighting detection engine 520. The current frame 602 includes one of the video frames 502, and is the frame currently being processed by the blob detection engine 504. The video frames 502 can include a sequence of video frames capturing events occurring in a scene.

At step 604, the process 600 includes performing background subtraction 604. Background subtraction is performed by the background subtraction engine 512. The background subtraction engine 512 can perform background subtraction on the current frame 602 to detect foreground pixels in the frame 602. The background subtraction segments moving objects in the current frame 602 from the global background in the video sequence and generates a foreground mask 618. As described above, the background subtraction engine 512 can use various types of background models to model the background of the scene captured by the video frames 502. For example, the scene can be modeled as a statistical model based on the relatively static pixels in previously processed frames that are not considered to belong to any moving region. The statistical model can include a Gaussian distribution model for each pixel location, with parameters of mean and variance being used to model each pixel location in the frames 502 of the video sequence. In another example, the scene can be modeled using a mixture of Gaussians (GMM), with the GMM modeling each pixel as a mixture of Gaussians and using an online learning algorithm to update the GMM. Each Gaussian model is represented with mean, standard deviation (or covariance matrix if the pixel has multiple channels), and weight.

After background subtraction is performed by the background subtraction engine 512, the process 600 includes determining, by the frame-level lighting detection engine 520 at step 606, whether a frame-level lighting condition change has occurred with respect to the current frame 602. When a frame-level lighting condition change is detected for the current frame 602, a frame-level lighting compensation process is performed at 608. However, when a frame-level lighting condition change is not detected, the blob detection engine 504 does not perform any frame-level lighting compensation for the frame 602. In some implementations, a blob-level lighting change compensation can be performed (described in further detail below) when a frame-level lighting condition change is not detected. Hence, whether to invoke frame-level (and in some cases blob-level) lighting compensation or not is an automatic determination based on detection of a frame-level lighting condition based on the characteristics of scene, and thus there is no need to have external interaction.

The frame-level lighting detection engine 520 can detect a frame-level lighting condition change by comparing characteristics of the current frame 602 with characteristics of a background picture 616 provided by the background subtraction engine 512. A background picture can be synthesized using the background models maintained by the background subtraction engine 512. For example, each pixel location in a background picture can be generated based on a respective background model maintained for each pixel location. A background picture can also be referred to as a natural background picture or a natural mean picture. There are several ways to generate a background picture. In one example, a background picture can be synthesized using the values of a statistical model (e.g., a Gaussian model) maintained for each pixel location in the background picture, regardless of whether a current pixel belongs to a background pixel or foreground pixel.

In another example, a background picture can be generated using a Gaussian mixture model (GMM) for each pixel location. For example, a pixel value of a synthesis background picture for a pixel location can be set as the expectation (or average or mean) of a model from the GMM for that pixel location, without taking into account whether the current pixel belongs to a background pixel or foreground pixel. In some examples, the model is chosen as the most probable model, which is the model with a highest weight from the GMM for a current pixel location can be used to synthesize the background picture for that pixel location. The model with the highest weight from a GMM is referred to herein as the most probable model. In some examples, the model from the GMM for a current pixel location whose distance to the current input pixel (in a current frame) is the smallest among all the existing models in the GMM for the current pixel location can be used to synthesize the background picture for that pixel location. The model from a GMM for a pixel location with the smallest distance to the current input pixel is referred to herein as the closest model.

In some implementations, the most probable model or the closest model can always be used to generate the mean (or expected) pixel values for the various pixel locations of the background picture. In some implementations, a closest background picture can be used, which can selectively choose a model to use for updating a pixel location, instead of always using a certain model (e.g., only the most probable model of the closest model). For example, the closest background picture selects for each of its pixel locations either the most probable model when a current pixel is identified to be a foreground pixel, or the closet model when the current pixel is identified to be a background pixel. As noted above, the most probable model for a pixel location is the model (e.g., from the GMM) that has the highest weight. The closest background model is the model whose distance to the current input pixel is the smallest among all the existing models for the current pixel location. As described by Equation 1 above, the intensity of each pixel location can be modelled by a mixture of K Gaussian Models. Each model has its own weight, mean and variance. The intensity of each pixel location of the background picture is the mean of the selected Gaussian Model of that location. If in current frame the current pixel location is determined as a foreground pixel, then the intensity of the background has to be estimated or guessed. The most possible intensity value is the mean μᵢ of the most probable model (the model with highest weight wᵢ) among the K Gaussian Models. If in the current frame the current location is determined as a background pixel, then the model which best represents the intensity of pixel location in the current frame is selected out of the K Gaussian models. For example, if the intensity of a pixel location in the current frame is p, the μᵢ which is closest to p than all other μⱼ (where j=1, . . . ,K, j !=i) can be selected as the intensity of the background picture for the current location.

The current frame 602 and the background picture 616 are used by the frame-level lighting detection engine 520 to detect whether a frame-level lighting condition change has occurred with respect to the current frame 602. In some examples, the lighting condition change can be detected by comparing the histogram of the background picture 616 and the histogram of the current frame 602. In such examples, the histograms themselves are compared, not the pixel values of the background picture 616 and the current frame 602. In some implementations, histograms of only one color component of the background picture 616 and current frame 602 can be compared, such as the luma component (Y) or a chroma component (Cb or Cr). In some implementations, histograms of all three color components can be compared. In one illustrative example, the histograms of the current frame 602 and the background picture 616 (the Y component in this example) are denoted as HisC (current frame) and HisM (of background picture). Using such notation, the frame-level lighting condition is calculated as sim=ΣMin(HisC[i], HisM[i])/ΣMax(HisC HisM[i]). If the similarity (sim) between the histograms is less than a similarity threshold Tₛ, a frame-level lighting condition change is detected for the current frame 602. If sim is greater than the similarity threshold Tₛ, a lighting condition change is not detected for the frame 602. The similarity threshold Tₛ, can be set to any suitable value (e.g., 0.75, 0.8, 0.85, or any other suitable value) to indicate a percentage of change that will be interpreted as a frame-level lighting condition change that effects the frame globally.

As noted above, a frame-level lighting compensation process can be performed at 608 when a frame-level lighting condition change is detected for the current frame 602. The frame-level lighting compensation is performed by the block-level picture mask generation engine 522 and includes performing block-level lighting condition compensation. For example, the background picture 616 can be compared with the current frame 602 on a block-by-block basis. The current frame 602 and the background picture 616 can be divided into blocks of pixels, and the blocks can be analyzed to determine whether blocks in the current frame 602 can be lighting compensated or not. If a block can be lighting compensated, the block is considered to be affected by a lighting condition change and is not considered further to contribute to a foreground region of the current frame 602. That is, the blocks can be analyzed to determine whether the detected lighting condition change affected the value of the pixels in the blocks of the current frame 602. If a block cannot be lighting compensated, the block is considered to be unaffected by the lighting change and may contribute to a foreground region of the frame 602. For example, the pixels of the block can be considered to not be changed due to a lighting change.

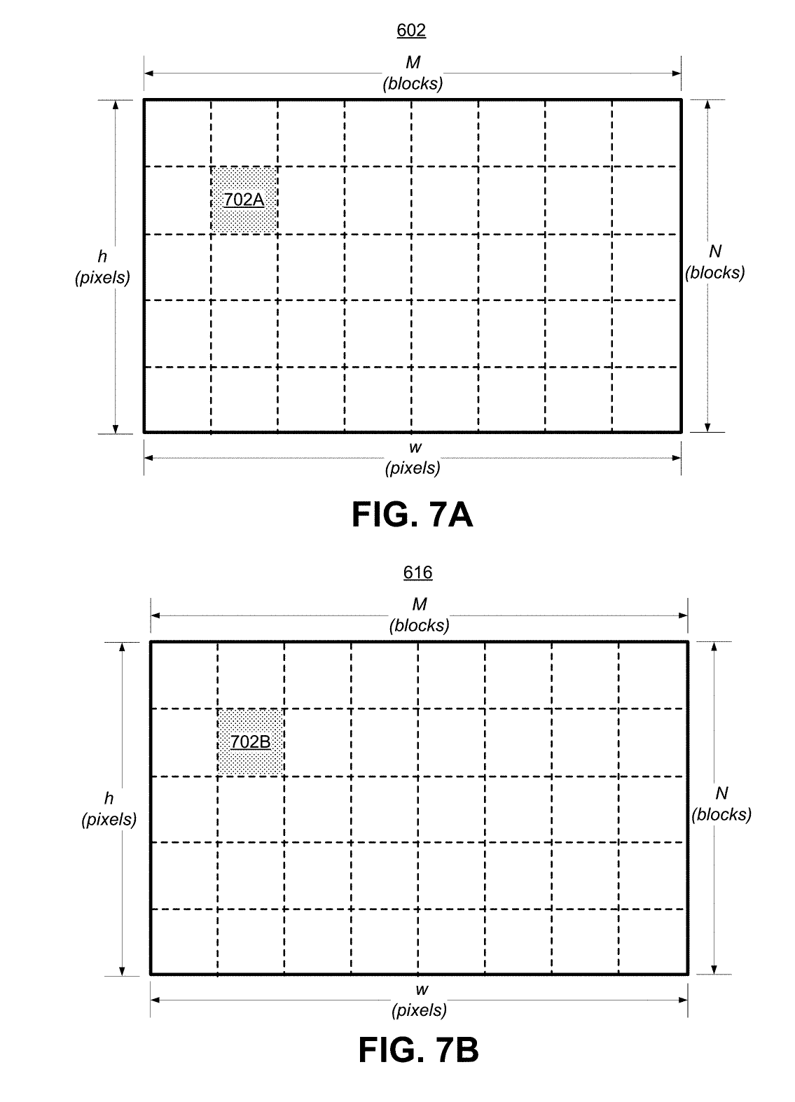

FIG. 7A shows an example of the current frame 602 that has been divided into a plurality of blocks. FIG. 7B shows an example of the background picture 616 that has also been divided into a plurality of blocks. The current frame 602 and the background picture 616 are divided into an equal number of M×N blocks (M blocks wide×N blocks high). In one illustrative example, the current frame 602 can include a resolution of 128 pixels (w)×80 pixels (h). The current frame 602 can be divided into 8 blocks (M)×5 blocks (N), with each block including 16 pixels×16 pixels. The background picture 616 can also be divided into an array of 8 blocks×5 blocks of 16 pixels×16 pixels each. One of ordinary skill will appreciate that the resolution and block partition used with respect to FIG. 7A and FIG. 7B are provided for illustrative purposes only, and that any resolution and block partition size can be used without departing from the scope of this description.

Because the frame 602 and the background picture 616 are divided into an equal number of blocks having equal sizes, each block in the current frame 602 has a location that corresponds to a location of a corresponding block in the background picture 616. For example, the location of block 702A in the current frame 602 corresponds to the location of the block 702B in the background picture 616. The block-level picture mask generation engine 522 can compare the blocks of the current frame 602 with the corresponding blocks of the background picture 616. For example, the current frame 602 can be compared to the background picture locally block-by-block to determine whether each block is affected by the lighting condition change (and thus whether each block can be lighting compensated).

A block of the current frame 602 can be determined to be affected by the lighting condition change based on a correlation calculated between the block and a corresponding block of the background picture 616. For example, a correlation between the block 702B of the background picture 616 and the block 702A of the current frame 602 is calculated by the block-level picture mask generation engine 522. A correlation can have values in the range of −1 to 1, inclusive. A correlation (also referred to as a correlation coefficient) is a number that quantifies some type of correlation and dependence, meaning statistical relationships between two or more random variables or observed data values. In one illustrative example, the correlation (co) can be defined as co=COV(X,Y)/Sqrt(COV(X,X)*COV(Y,Y)). The covariance COV(X,X) is the variance of X (denoted as VAR(X)), and the covariance COV(Y,Y) is the variance of Y (denoted as VAR(Y)). The covariance of X and Y is defined as COV(X,Y) =E((X−E(X))(Y−E(Y))). E(X) is the expectation of X (or average of X), E(Y) is the expectation of Y (or average of Y)

Referring to the frame 602 and the background picture 616, a positive and high correlation value between the block 702A and the block 702B indicates that pixel values of the block 702A are expected to be statistically similar as the pixel values of the block 702B and thus may be caused by lighting change. For example, when the correlation determined between a block of a current frame 602 and a corresponding block of the background picture 616 (e.g., blocks 702A and 702B) is higher than a threshold correlation T_{c}, the block of the current frame 602 can be determined to be affected by the lighting condition change. That is, it is determined that the block can be lighting compensated. For example, as noted above, a high correlation value between blocks 702A and 702B indicates that the pixels of the block 702A should be statistically similar (e.g., linearly or other statistical relationship) as the pixels of the block 702B.

However, due to the lighting condition change, the pixels of the block 702A in the current frame will be changed in a manner that is not statistically related to the values in the background picture 702B. That is, the correlation relationship between the blocks 702A and 702B is not maintained when the pixels of the block 702A are affected by the lighting change. When a correlation between corresponding blocks of the current frame 602 and the background picture 616 is below the threshold correlation T_{c}, the block of the current frame 602 can be determined as not being affected by the lighting condition change. When a correlation is equal to the threshold correlation T_{c}, the block of the current frame 602 can be determined as either being affected or not being affected by the lighting change, depending on the particular implementation. The threshold correlation T_{c} can be set to any suitable value, such as 0.75, 0.8, 0.9, or other suitable correlation value.

In some examples, a frame can contain one or more homogeneous regions that contain little to no texture. Texture in a frame refers to the amount of variation in neighboring pixel values (e.g., a highly textured region can contain much variation in pixel intensities of adjacent pixels). For example, in a region of a frame having a smooth texture, the range of values in the neighborhood around a pixel of the region will be small. In a region of a frame having a rough texture, the range of values around a pixel in the region should be larger. In order to avoid white noise for a homogenous region, the variance of the pixel values in each block can be used to determine if the block 702B of the background picture 616 and/or the block 702A of the current frame 602 contain sufficient texture. If both blocks 700A and 700B have no texture, the current block 702A belongs to a homogeneous region that may be affected by the lighting change as compared to a homogenous region with just a changed average intensity. In this case, even though the correlation value is not large (due to the fact that COV(X,Y), COV(X,X) and COV(Y,Y) may all be very close to zero), the two homogeneous regions may be different from each other just due to the uniform intensity change.

Based on the results of the correlation determinations between blocks of the current frame 602 and corresponding blocks of the background picture 616, the block-level picture mask generation engine 522 can generate a block-level picture mask of the blocks for the current frame 702. For example, the block-level picture mask for the current frame 602 can include a binary image or picture that has a 0 or a 1 value for each block of the picture 602. In some examples, a 0 value is used to indicate that a block is affected by the lighting change (can be lighting compensated) and a 1 value is used to indicate that a bock is not affected by the lighting condition change (cannot be compensated). For example, a 0 value is assigned to a block of the current frame 602 when the value of a correlation between the block and a corresponding block in the background picture 616 is higher than the threshold correlation T_{c} (or equal to in some cases). A 1 value is assigned to a block of the current frame 602 when the value of a correlation between the block and a corresponding block in the background picture 616 is less than the correlation threshold T_{c} (or equal to in some cases).

In some examples, the block-level picture mask (the block-level picture mask is a picture, so each pixel, although is representing a block, is processed as a pixel) can be processed by the morphology engine 514 before the picture mask is finalized. Erosion and dilation functions can be applied to the pixels of the picture mask to reduce noise present in the mask. The erosion and dilation functions can be similar those described above with respect to FIG. 3.

For example, an erosion function can be applied to change a 1 value assigned to the pixels of a block in the block-level mask to a 0 value when one or more neighboring pixels within a window (e.g., a 3×3 window) have a 0 value. One or more dilation functions can then be applied to change a 0 value of the pixels of a block to a 1 value when one or more neighboring pixels within a window (e.g., a 3×3 window) have a 1 value. In one illustrative example, a single erosion function using a 3×3 window can be followed by a number of dilation functions (e.g., 3 dilation functions or other suitable number), each using a 3×3 window.

In some examples, after a final block-level picture mask is generated (with or without morphology operations applied), the block-level picture mask can be mapped to be a pixel-level picture mask 620 (denoted as lightNotComp). The block-level picture mask conversion engine 524 can generate the pixel-level mask 620 by applying a value assigned to a block in the block-level mask to all pixels within the block. For example, if a block has a 1 value assigned to it in the block-level mask (indicating the block is not affected by the lighting condition change), all pixels within the block will be assigned a 1 value in the pixel-level picture mask 620. Similarly, if a block has a 0 value assigned to it in the block-level mask (indicating the block is affected by the lighting change), all pixels within the block will be assigned a 0 value in the pixel-level mask 620.

The pixel-level picture mask 620 can be added on top of the foreground mask 618 (generated by the background subtraction engine 512) to produce a light-compensated foreground mask 622 for the current frame 602. For example, at 610, the process 600 includes comparing the foreground mask 618 of the current frame 602 to the pixel-level picture mask 620 of the current frame 602. The mask comparison engine 526 can compare the pixel-level mask 620 to the foreground mask 618 to determine if each pixel in the current frame is to be finally determined as a foreground pixel (a 1 value in the foreground mask 618) or a background pixel (a 0 value in the foreground mask 618). For example, if a pixel is identified as a foreground pixel after background subtraction (thus having a 1 value in the foreground mask 618) and the pixel is determined to not be affected by the lighting change (thus having a 1 value in the pixel-level picture mask 620), the pixel is finally identified as a foreground pixel. However, if a pixel has a 1 value in the foreground mask 618 (a foreground pixel) and the pixel is determined to have a 0 value in the pixel-level picture mask 620 (thus determined to be affected by the lighting change), the pixel is determined to not be a foreground pixel and the foreground mask is modified to have a 0 value for that pixel. The final pixel-value determination can be denoted as fgmask=fgmask&lightNotComp, wherein fgmask is the foreground mask and lightNotComp is the mapped pixel-level mask.

The light-compensated foreground mask 622 can then be provided to the connected component analysis engine 516. Connected component analysis can be performed on the light-compensated foreground mask 622 to detect blobs for the current frame, as previously described with respect to the connected component analysis engine 316. The detected blobs can be provided to the blob processing engine 518 for further processing (e.g., for generating bounding boxes, filtering blobs, or other functions). For example, the process 600 can include performing connected component analysis (CCA) and blob processing at 612. The processed blobs 508 are then output for tracking and any other operations that might be performed.

When a frame-level lighting condition change is not detected by the frame-level lighting detection engine 520 (step 606 of FIG. 6), the blob detection engine 504 does not perform any frame-level lighting compensation. For example, if the similarity (sim) between the histograms of the current frame 602 and the background picture 616 is less than the similarity threshold Tₛ (or equal to in some cases), a frame-level lighting condition change is not detected for the current frame 602. In such cases, the blob detection engine 504 can detect blobs normally, as described with respect to the blob detection engine 104. For example, morphology engine 514 can perform morphology operations (e.g., erosion and dilation functions) on the foreground mask 618 generated by the background subtraction engine 512. After morphology operations are applied, the foreground mask 618 can be provided to the connected component analysis engine 516. Connected component analysis can be performed on the foreground mask 618 to detect blobs for the current frame 602, as previously described. The connected components (detected blobs) can be provided to the blob processing engine 518 for further processing (e.g., for generating bounding boxes, filtering blobs, or other functions), and the processed blobs 508 are output for tracking and any other operations that might be performed. For example, the process 600 can include performing object tracking at 614. As described below, blob-level lighting compensation can be performed during blob analysis in object tracking.

The frame-level lighting condition detection described above is realized in a way that only relatively big lighting changes are detected, which require frame-level lighting compensation. Smaller lighting condition changes can be compensated at the blob level. As noted previously, when a frame-level lighting condition change is not detected for a current frame, a blob-level lighting condition change compensation can be performed. For example, strong lighting condition changes may result from a normal lighting condition change, which may gradually become stronger and stronger. In this case, there might be small lighting condition changes even when the global frame-level lighting condition change detection indicates negative results. Blob-level lighting compensation systems and methods can be used to detect such lighting condition changes, such as local lighting change or slight global lighting change. The blob-level false positive removing mechanism may be invoked only when the current frame is not considered to have a global lighting condition change. For example, only if a lighting condition change does not occur on a global or frame level (thus no block-level compensation has applied), the blob-level lighting compensation can be applied.

The blob-level lighting change compensation can be performed during the object tracking process, and provides a false positive removing mechanism to accommodate lighting condition changes that were not detected on the global level. For example, the blob-level compensation can prevent blob trackers from being converted to normal and output when an associated blob is determined to be caused by a lighting change.

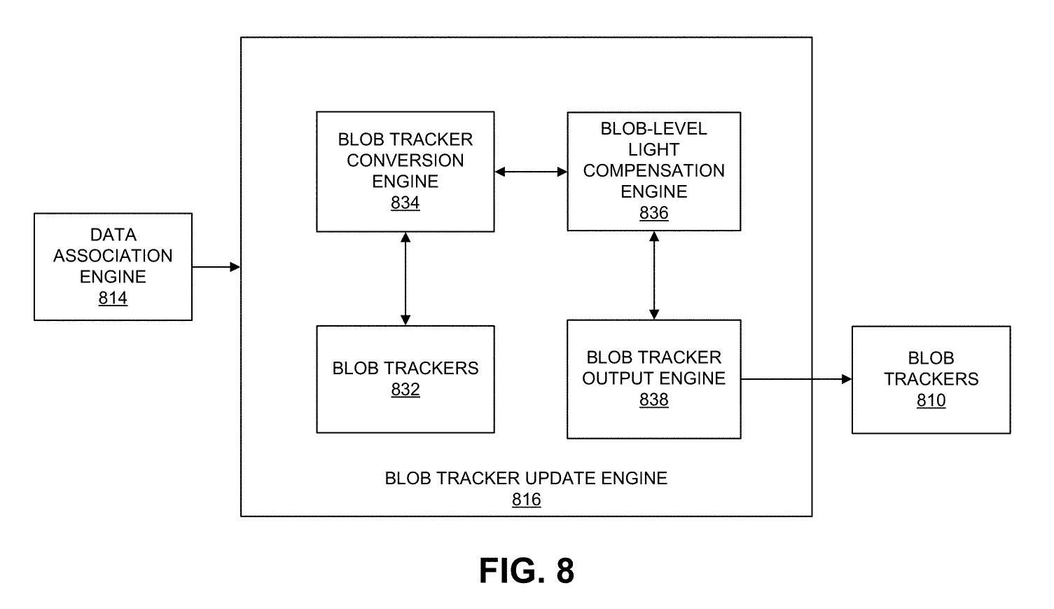

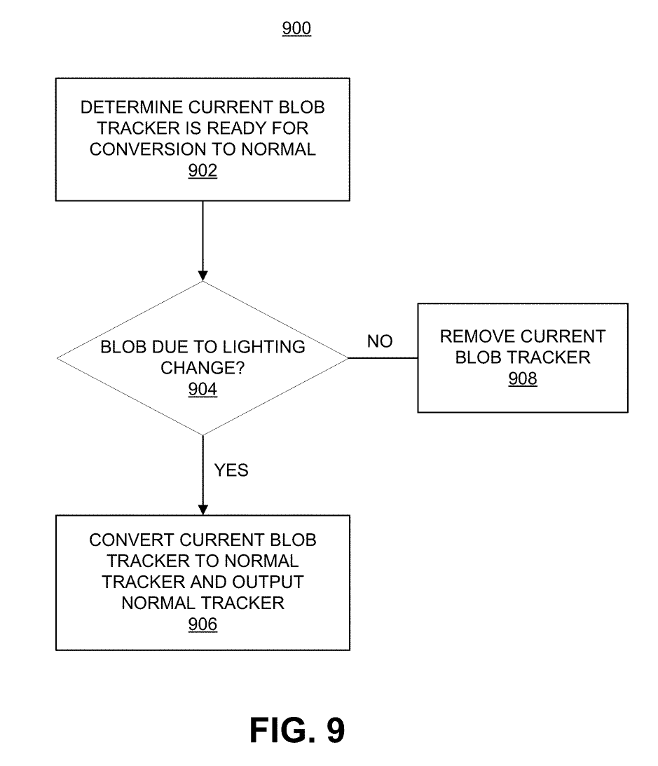

FIG. 8 is a block diagram illustrating an example of a blob tracker update engine 816 including components for performing the blob-level lighting change compensation. The blob tracker update engine 816 includes a blob tracker store 832, a blob tracker conversion engine 834, a blob-level light compensation engine 836, and a blob tracker output engine 838. FIG. 9 is a flowchart illustrating an example of a process 900 of performing blob-level lighting condition change compensation, which will be described with respect to the components of the blob tracker update engine 816.

During the object tracking process, when a blob tracker has been continuously associated with one or more blobs and a threshold duration has passed, the tracker can be promoted or converted to be a normal tracker. The threshold duration can be a number of frames (e.g., at least N frames) or an amount of time. In one illustrative example, the threshold duration for which a tracker needs to be associated with a blob is 30 frames before being converted to a normal tracker. Other durations can also be used. When converted to normal, a normal tracker and the blob it is associated with are output as an identified tracker-blob pair to the video analytics system. For example, a tracker-blob pair can be output at the system level as an event (e.g., presented as a tracked object on a display, output as an alert, or other suitable event) when the tracker is promoted to be a normal tracker.

In some examples, the blob-level lighting change compensation can be performed at any point during the tracking process. In some examples, the blob-level compensation may only be performed for blobs associated with new trackers when it is time for the new trackers (and the associated blobs) to be converted to normal trackers (and thus are ready to be output to the system level as an event). In such examples, instead of applying the blob-level lighting compensation for all detected blobs, the blob-level compensation can be performed for trackers that are being considered for promotion to normal status, which can greatly reduce complexity. In such a situation, there may already be steps in place to identify trackers and associated blobs as false positive, in which case there is no need to output such trackers. For example, if a tracker went through all prior blob filtering steps, and is ready to be converted to normal and output, the blob-level lighting compensation can be applied.

Turning to FIG. 9, the process 900 includes determining, at 902, whether a current blob tracker is ready for conversion to a normal tracker. The blob tracker conversion engine 834 can determine when the current blob tracker is ready for conversion to a normal status based on a threshold duration. For example, when the blob tracker has been continuously associated with a blob for the threshold duration (e.g., 30 frames, 60 frames, 1 second, 2 seconds, or other suitable duration), the blob tracker conversion engine 834 can determine the tracker is ready to be converted to a normal tracker.

At 904, the process 900 includes determining whether a blob of a current frame is caused by a lighting condition change in response to determining that the current blob is ready for conversion to normal. The blob-level compensation engine 836 can perform a blob-level comparison between a bounding box of the blob of the current frame and a corresponding bounding box region in a background picture to determine whether the blob was detected due to a lighting condition change. In some examples, a similar correlation approach as that described above for the frame-level compensation can be applied for the current bounding box associated with the blob tracker and associated blob. The blob-level compensation engine 836 can calculate the correlation between the bounding box of the blob of the current frame and the corresponding bounding box region in the background picture. If the correlation is high enough (e.g., greater than 0.75, 0.8, 0.9, or other suitable correlation value), the blob is considered to be caused by a lighting condition change (and thus can be lighting compensated). For example, if a high correlation exists between the corresponding bounding box regions of the blob and the background picture, and the background picture indicates the bounding box region is background (based on the mean values for the pixel locations in the region), the blob should also be background based on the high correlation. In such an example, if a change occurs to the pixel values for the bounding box region in the current frame (causing the blob to be detected), the pixel value change is likely due to a lighting change. If the bounding box can be lighting compensated (indicating the blob is caused by a lighting change), the blob is not considered to be a real object (a false positive) and thus is determined to be a background blob.

At 908, the process 900 includes removing a current blob tracker when the associated blob is considered to be caused by a lighting condition change. For example, the blob tracker may be killed since the blob is a false positive object. At 910, the process 900 includes converting the current blob tracker to a normal tracker and outputting the normal tracker when the blob is determined not to be affected by any lighting condition change. For example, the bob tracker output engine 838 can allow the current blob tracker to be output as one of the blob trackers 810.

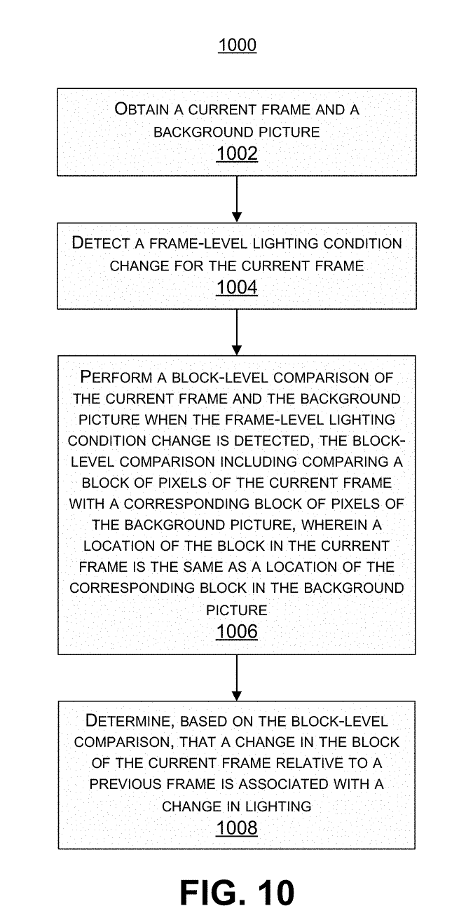

FIG. 10 illustrates an example of a process 1000 of compensating for lighting changes in one or more video frames using the lighting compensation techniques described herein. At 1002, the process 1000 includes obtaining a current frame and a background picture. Any suitable background picture can be used. In some implementations, the background picture is based at least on part on the current frame. For example, as described above, a background picture can be synthesized using the background models maintained for each pixel location (e.g., one or more models for each pixel location) by the background subtraction engine 512. In some aspects, the background picture includes corresponding mean values for each pixel location of the background picture. The mean values in each pixel location can be determined by taking into account the pixel values at each corresponding pixel location in the current frame. In some aspects, a pixel value for a pixel location in the background picture is determined using a background model selected from a plurality of background models. In some examples, the selected background model has a highest weight from among the plurality of background models. For instance, the selected model used to synthesize the background picture for that pixel location can include the most probable model, which is the model with the highest weight from a GMM for the pixel location. In some examples, the selected background model is the model from the plurality of background models that has a smallest distance to a value of a current pixel in the current frame at the pixel location. For instance, the selected model can include the closest model, as described above. In some examples, the background picture includes a closest background picture, as described above. For instance, the most probable model can be used by the closest background picture when a current pixel in the current frame is identified to be a foreground pixel, and the closet model can be used when the current pixel is identified to be a background pixel. In some implementations, the background picture is not based on the current frame. For example, the background picture can be generated using one or more background models that are not updated at every frame (e.g., a background picture that is updated every other frame, every n-number of frames with n being equal to any integer greater than 2, or any other suitable update period). In another example, the background picture can be pre-determined so that it is not updated based on input frames. For instance, a background picture can be manually generated to represent the background of a scene.

At 1004, the process 1000 includes detecting a frame-level lighting condition change for the current frame. For example, detecting the frame-level lighting condition change for the input frame can include comparing a first histogram of the current frame to a second histogram of the background picture to determine a similarity between the first histogram and the second histogram. In illustrative example, the frame-level lighting condition can be calculated as sim=ΣMin(HisC[i], HisM[i])/ΣMax(HisC[i], HisM[i]), where the first histogram of the current frame is denoted as HisC and the second histogram of the background picture is denoted as HisM. Detecting the frame-level lighting condition change can further include detecting the frame-level lighting condition change when the similarity between the first histogram and the second histogram is less than a similarity threshold. In one illustrative example, if the similarity (sim) between the first and second histograms is less than a similarity threshold Tₛ, the frame-level lighting condition change is detected for the current frame.

At 1006, the process 1000 includes performing a block-level comparison of the current frame and the background picture when the frame-level lighting condition change is detected. The block-level comparison including comparing a block of pixels of the current frame with a corresponding block of pixels of the background picture. A location of the block in the current frame is the same as a location of the corresponding block in the background picture. For example, as shown in the illustrative example shown in FIG. 7A and FIG. 7B, the location of the block 702A has a same location in the current frame 602 as the block 702B in the background picture 616.

At 1008, the process 1000 includes determining, based on the block-level comparison, that a change in the block of the current frame relative to a previous frame is associated with a change in lighting. In some examples, comparing the block of the current frame with the corresponding block of the background picture includes determining a correlation between the block of the current frame and the corresponding block of the background picture. In such examples, determining, based on the block-level comparison, that the change in the block of the current frame is associated with the change in lighting includes determining the correlation between the block of the current frame and the corresponding block of the background picture is greater than a threshold. In one illustrative example, when the correlation determined between the block of the current frame and the corresponding block of the background picture is higher than the threshold correlation T_{c} (as described above), the block of the current frame is determined to be affected by the change in lighting. A similar block-by-block comparison can be performed for each block in the current frame using the corresponding blocks from the background picture.

In some examples, the process 1000 further includes generating a block-level picture mask including a lighting value for each block. A first lighting value (e.g., a 0 value) is assigned to blocks of the current frame that include changes associated with the change in lighting, a second lighting value (e.g., a 1 value) is assigned to blocks of the current frame that are not associated with the change in lighting. For example, the first value for a first block of the current frame indicates a difference between the first block and a corresponding first block of the background picture is caused by the change in lighting, and the second value for a second block of the current frame indicates a difference between the second block and a corresponding second block of the background picture is not caused by the change in lighting. The first value can be assigned to the first block when a correlation between the first block and the corresponding first block is higher than the threshold correlation. The second value can be assigned to the second block when a correlation between the second block and the corresponding second block is below the threshold correlation. All of the blocks of the current frame can be assigned either the first value or the second value based on the correlation determined between each block of the current frame and each corresponding block of the background picture.

In some examples, the process 1000 includes converting the block-level picture mask to a pixel-level picture mask by mapping a respective lighting value for each block to all pixels in each block. For example, if a block has the second value (e.g., 1) assigned to it in the block-level mask (indicating the block is not affected by the lighting condition change), all pixels within the block will be assigned the second value in the pixel-level picture mask. In another example, if a block has the first value assigned to it in the block-level mask (indicating the block is affected by the lighting change), all pixels within the block will be assigned the first value in the pixel-level mask.

In examples in which a pixel-level picture mask is used, the process 1000 can include obtaining a foreground mask for the current frame, comparing the pixel-level picture mask to the foreground mask, and determining whether one or more foreground pixels of the foreground mask are to be maintained as foreground pixels based on the comparison of the pixel-level picture mask to the foreground mask. A foreground pixel of the foreground mask is maintained as the foreground pixel when the second lighting value is assigned to the foreground pixel in the pixel-level picture mask. For example, when a pixel is identified as a foreground pixel after background subtraction (and thus has a 1 value in the foreground mask) and the pixel is determined to not be affected by the lighting change (and thus has a 1 value in the pixel-level picture mask), the pixel is finally identified as a foreground pixel.

In some implementations, the process 1000 can perform morphology operations on the block-level picture mask. For example, the process 1000 can include performing an erosion function on the block-level picture mask. The erosion function sets the first lighting value to the second lighting value for one or more blocks of the block-level picture mask. In one illustrative example, the erosion function can be applied to change a 1 value assigned to the pixels of a block in the block-level picture mask to a 0 value when one or more neighboring pixels within a window (e.g., a 3×3 window) have a 0 value. The process 1000 can also include performing one or more dilation functions on the block-level picture mask. The one or more dilation functions set the second lighting value to the first lighting value for one or more blocks of the block-level picture mask. In one illustrative example, the one or more dilation functions can change a 0 value assigned to the pixels of a block to a 1 value when one or more neighboring pixels within a window (e.g., a 3×3 window) have a 1 value. In some examples, a single erosion function using a 3×3 window can be followed by three dilation functions, each using a 3×3 window. One of ordinary skill will appreciate that any suitable number of erosion functions and dilation functions can be used.

In some examples, the process 1000 can perform blob-level lighting compensation in addition to the frame-level lighting compensation. For example, the process 1000 can include obtaining a subsequent frame and an additional background picture. The subsequent frame is obtained later in time than the current frame. In such examples, the process 1000 further includes determining a frame-level lighting condition change is not present for the subsequent frame. For example, a frame-level lighting condition change is not detected for the subsequent frame when the similarity between a histogram of the subsequent frame and the second histogram of the background picture (or another histogram for an updated background picture with pixel values that are updated based on the pixel values of the subsequent frame) is greater than the similarity threshold. The process 1000 further includes performing a blob-level comparison of the subsequent frame and the additional background picture when the frame-level lighting condition change is determined not to be present for the subsequent frame. As described herein, a blob includes pixels of at least a portion of one or more foreground objects in a video frame.

In examples in which blob-level lighting compensation is performed, the process 1000 further includes determining, based on the blob-level comparison, that a blob of the subsequent frame is associated with a change in lighting. The blob includes pixels of at least a portion of a foreground object in the subsequent frame. The blob-level comparison can include comparing blobs of the subsequent frame with corresponding blobs of the additional background picture. For example, the comparison can include determining a correlation between a bounding box of a blob of the subsequent frame and a corresponding bounding box region in the background picture, as described above. In such examples, the process 1000 further includes determining the blob is a background blob based on determining the change in the blob is associated with the change in lighting. In some examples, the blob-level compensation may only be performed for blobs associated with new trackers when it is time for the new trackers (and the associated blobs) to be converted to normal trackers (and thus are ready to be output to the system level as an event).

In some examples, a process can perform blob-level lighting compensation even if frame-level lighting compensation is not performed. For example, the blob-level lighting compensation can be performed for a current frame when a frame-level lighting condition change is determined not to be present for the current frame. In one illustrative example, a process can include obtaining a current frame and a background picture, and determining a frame-level lighting condition change is not present for the current frame. For example, a frame-level lighting condition change is not detected for the current frame when the similarity between a histogram of the subsequent frame and the second histogram of the background picture (or another histogram for an updated background picture with pixel values that are updated based on the pixel values of the subsequent frame) is greater than the similarity threshold. The process can further include performing a blob-level comparison of the current frame and the obtained background picture when the frame-level lighting condition change is determined not to be present for the current frame. The process can further include determining, based on the blob-level comparison, that a blob of the current frame is associated with a change in lighting. The blob includes pixels of at least a portion of a foreground object in the current frame.

The blob-level comparison can include comparing blobs of the current frame with corresponding blobs of the obtained background picture. For example, the comparison can include determining a correlation between a bounding box of a blob of the current frame and a corresponding bounding box region in the background picture. The process can further include determining the blob is a background blob based on determining the change in the blob is associated with the change in lighting. In some examples, the blob-level compensation may only be performed for blobs associated with new trackers when it is time for the new trackers (and the associated blobs) to be converted to normal trackers (and thus are ready to be output to the system level as an event).

In some examples, the process 1000 may be performed by a computing device or an apparatus, such as the video analytics system 100. For example, the process 1000 can be performed by the video analytics system 100, the blob detection engine 104 or 504, the object tracking engine 106, and/or the blob tracker update engine 816 shown in FIGS. 1, 3, 4, 5, and 8, respectively. In some cases, the computing device or apparatus may include a processor, microprocessor, microcomputer, or other component of a device that is configured to carry out the steps of process 1000. In some examples, the computing device or apparatus may include a camera configured to capture video data (e.g., a video sequence) including video frames. For example, the computing device may include a camera device (e.g., an IP camera or other type of camera device) that may include a video codec. In some examples, a camera or other capture device that captures the video data is separate from the computing device, in which case the computing device receives the captured video data. The computing device may further include a network interface configured to communicate the video data. The network interface may be configured to communicate Internet Protocol (IP) based data.

Process 1000 is illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

By performing the lighting compensation systems and methods described above, various lighting condition changes can be compensated for at both the blob detection and the blob/object tracking stages. The systems and methods provide a unified solution that accommodates perfect lighting condition (with no lighting condition change), slight lighting condition changes, and dramatic lighting condition changes.

The lighting compensation methods can be evaluated in an end-to-end IP camera (IPC) system, wherein the blob/object detection rate and the blob/object tracking rate are important numbers compared with a ground truth blob detection and tracking method. The proposed method has a clear advantage for subjective quality improvements. Even for objective quality improvements for all video clips that do not have dramatic lighting condition changes, the proposed method helps in reducing the false positive rate. For example, in one typical video sequence that has a lighting change due to cloud movement, the false positive rate using the proposed method is 0.2857, which is significantly smaller than the false positive rate of 0.3214 achieved using the anchor method. The true positive rate may be unchanged and the tracking rate can be increased from 0.7423 to 0.7718.

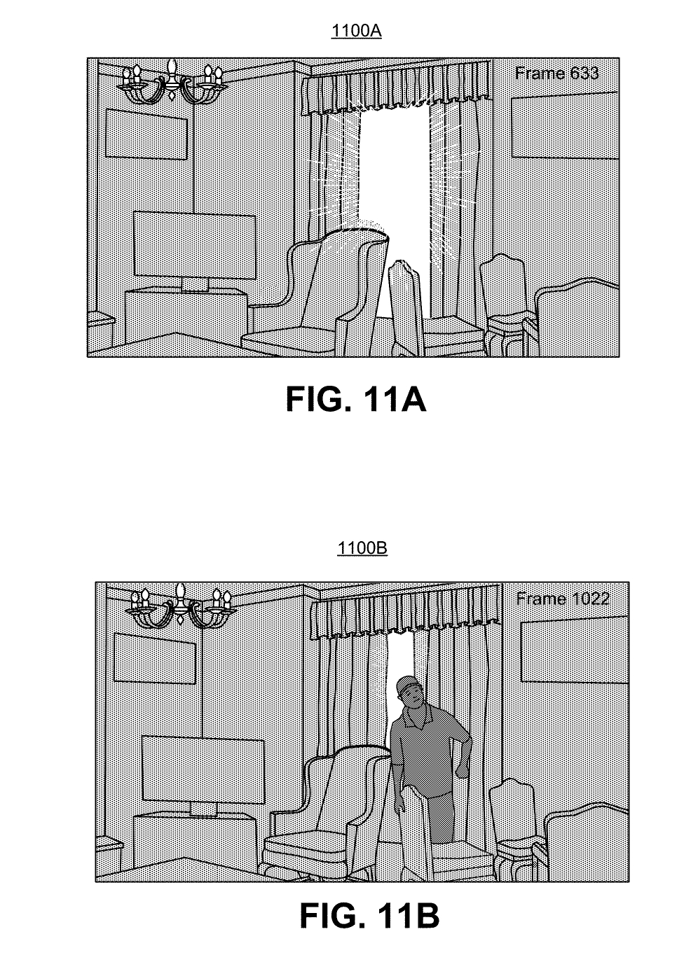

Various illustrative examples of video frames with lighting condition changes are shown in FIG. 11A-FIG. 13. For example, FIG. 11A and FIG. 11B show video frames 1100A and 1100B capturing a scene that experiences lighting condition changes. As the curtain is opened by a person, as shown in FIG. 11A, the light coming through the window becomes brighter. The frame 1100A includes a frame number 633. In frame 1100B, a person who came through the window can be seen in the room. The frame 1100B includes a frame number 1122, approximately 400 frames after frame 1100A. The lighting compensation techniques described herein are not used for the frames 1100A and 1100B, and thus the person cannot be detected because of the lighting change. For example, the anchor method without lighting condition change detection will lead to a very dynamic background, and thus the real moving foreground objects cannot be detected in a long duration.

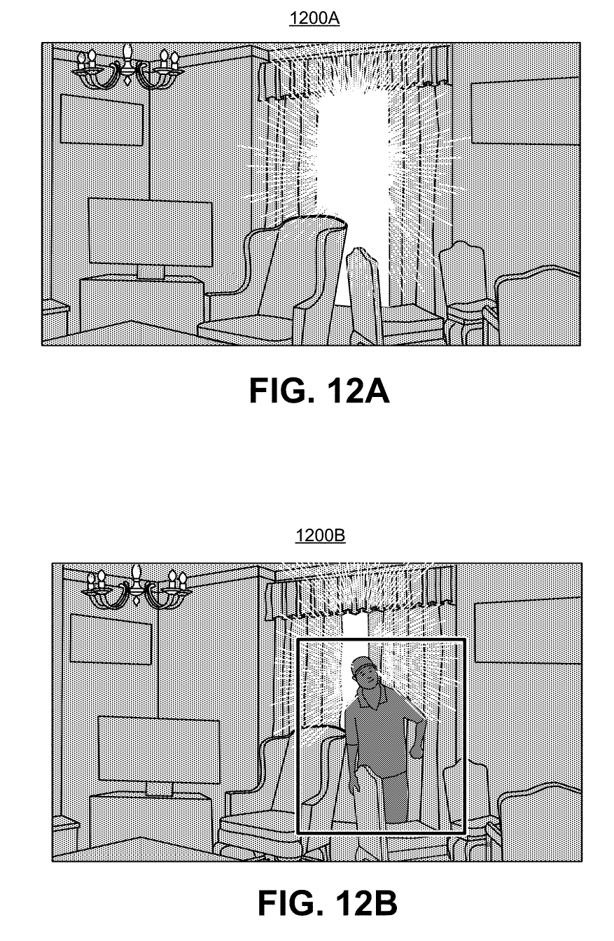

FIG. 12A and FIG. 12B show video frames 1200A and 1200B capturing the same scene as that shown in FIG. 11A and FIG. 11B. The lighting compensation techniques described herein were used for the frames 1200A and 1200B, allowing the person to be tracked with the bounding box shown in frame 1200B. Using such techniques, objects in relevant areas can always be tracked, even when there is a strong or slight lighting condition change. Only in this way, such a break-in event can be finally reported at the system level when lighting conditions change. Using the anchor method, such a break-in event is not captured.

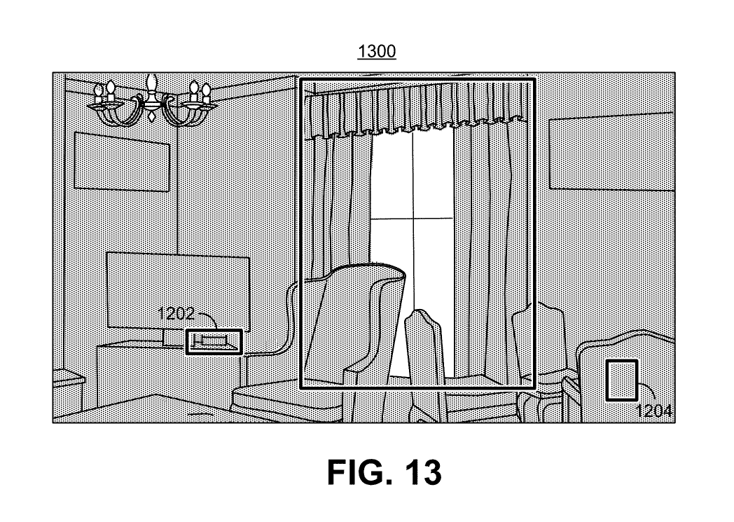

FIG. 13 is an illustration of a video frame 1300 capturing a scene with lighting condition changes. As shown in the frame 1300, in the scenario described above when no blob-level lighting compensation is applied, various false positive blobs will be easily generated and tracked (e.g., based on the lighting change affecting background subtraction). For example, false positive blobs are generated and tracked with trackers 1302 and 1304. Such detection and tracking of false positives causes obvious detection quality degradation.

The lighting condition change compensation techniques discussed herein may be implemented using compressed video or using uncompressed video frames (before or after compression). An example video encoding and decoding system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

In the foregoing description, aspects of the application are described with reference to specific embodiments thereof, but those skilled in the art will recognize that the invention is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Ws claimed is:

1. A method of compensating for lighting changes in one or more video frames, comprising:
obtaining a current frame and a background picture;
detecting a frame-level lighting condition change for the current frame;
performing a block-level comparison of the current frame and the background picture when the frame-level lighting condition change is detected, the block-level comparison including comparing a block of pixels of the current frame with a corresponding block of pixels of the background picture, wherein a location of the block in the current frame is the same as a location of the corresponding block in the background picture; and
determining, based on the block-level comparison, that a change in the block of the current frame relative to a previous frame is associated with a change in lighting.

2. The method of claim 1, further comprising:
obtaining a subsequent frame and an additional background picture, wherein the subsequent frame is obtained later in time than the current frame;
determining a frame-level lighting condition change is not present for the subsequent frame; and
performing a blob-level comparison of the subsequent frame and the additional background picture when the frame-level lighting condition change is determined not to be present for the subsequent frame, wherein a blob includes pixels of at least a portion of one or more foreground objects in a video frame.

3. The method of claim 2, further comprising:
determining, based on the blob-level comparison, that a blob of the subsequent frame is associated with a change in lighting, wherein the blob of the subsequent frame includes pixels of at least a portion of a foreground object in the subsequent frame; and
determining the blob is a background blob based on determining the change in the blob is associated with the change in lighting.

4. The method of claim 2, wherein the blob-level comparison includes comparing blobs of the subsequent frame with corresponding blobs of the additional background picture.

5. The method of claim 1, wherein detecting the frame-level lighting condition change for the current frame includes:
comparing a first histogram of the current frame to a second histogram of the background picture to determine a similarity between the first histogram and the second histogram; and
detecting the frame-level lighting condition change when the similarity between the first histogram and the second histogram is less than a similarity threshold.

6. The method of claim 1, wherein comparing the block of the current frame with the corresponding block of the background picture includes:
determining a correlation between the block of the current frame and the corresponding block of the background picture.

7. The method of claim 6, wherein determining, based on the block-level comparison, that the change in the block of the current frame is associated with the change in lighting includes:
determining the correlation between the block of the current frame and the corresponding block of the background picture is greater than a threshold.

8. The method of claim 1, further comprising:
generating a block-level picture mask including a lighting value for each block, wherein a first lighting value is assigned to blocks of the current frame that include changes associated with the change in lighting, and wherein a second lighting value is assigned to blocks of the current frame that are not associated with the change in lighting.

9. The method of claim 8, wherein the first value for a first block of the current frame indicates a difference between the first block and a corresponding first block of the background picture is caused by the change in lighting, and wherein the second value for a second block of the current frame indicates a difference between the second block and a corresponding second block of the background picture is not caused by the change in lighting.

10. The method of claim 8, further comprising:
converting the block-level picture mask to a pixel-level picture mask, wherein converting includes mapping a respective lighting value for each block to all pixels in each block.

11. The method of claim 10, further comprising:
obtaining a foreground mask for the current frame;
comparing the pixel-level picture mask to the foreground mask; and
determining whether one or more foreground pixels of the foreground mask are to be maintained as foreground pixels based on the comparison of the pixel-level picture mask to the foreground mask, wherein a foreground pixel of the foreground mask is maintained as the foreground pixel when the second lighting value is assigned to the foreground pixel in the pixel-level picture mask.

12. The method of claim 8, further comprising:
performing an erosion function on the block-level picture mask, the erosion function setting the first lighting value to the second lighting value for one or more blocks of the block-level picture mask.

13. The method of claim 8, further comprising:
performing one or more dilation functions on the block-level picture mask, the one or more dilation functions setting the second lighting value to the first lighting value for one or more blocks of the block-level picture mask.

14. The method of claim 1, wherein the background picture includes corresponding mean values for each pixel location of the background picture.

15. The method of claim 1, wherein a pixel value for a pixel location in the background picture is determined using a background model selected from a plurality of background models, and wherein the selected background model has a highest weight from among the plurality of background models.

16. An apparatus comprising:
a memory configured to store video data; and
a processor configured to:
obtain a current frame and a background picture;
detect a frame-level lighting condition change for the current frame;
perform a block-level comparison of the current frame and the background picture when the frame-level lighting condition change is detected, the block-level comparison including comparing a block of pixels of the current frame with a corresponding block of pixels of the background picture, wherein a location of the block in the current frame is the same as a location of the corresponding block in the background picture; and
determine, based on the block-level comparison, that a change in the block of the current frame relative to a previous frame is associated with a change in lighting.

17. The apparatus of claim 16, wherein the processor is further configured to:
obtain a subsequent frame and an additional background picture, wherein the subsequent frame is obtained later in time than the current frame;
determine a frame-level lighting condition change is not present for the subsequent frame; and
perform a blob-level comparison of the subsequent frame and the additional background picture when the frame-level lighting condition change is determined not to be present for the subsequent frame, wherein a blob includes pixels of at least a portion of one or more foreground objects in a video frame.

18. The apparatus of claim 17, wherein the processor is further configured to:
determine, based on the blob-level comparison, that a blob of the subsequent frame is associated with a change in lighting, wherein the blob includes pixels of at least a portion of a foreground object in the subsequent frame; and
determine the blob is a background blob based on determining the change in the blob is associated with the change in lighting.

19. The apparatus of claim 17, wherein the blob-level comparison includes comparing blobs of the subsequent frame with corresponding blobs of the additional background picture.

20. The apparatus of claim 16, wherein detecting the frame-level lighting condition change for the current frame includes:
comparing a first histogram of the current frame to a second histogram of the background picture to determine a similarity between the first histogram and the second histogram; and
detecting the frame-level lighting condition change when the similarity between the first histogram and the second histogram is less than a similarity threshold.

21. The apparatus of claim 16, wherein comparing the block of the current frame with the corresponding block of the background picture includes:
determining a correlation between the block of the current frame and the corresponding block of the background picture.

22. The apparatus of claim 21, wherein determining, based on the block-level comparison, that the change in the block of the current frame is associated with the change in lighting includes:
determining the correlation between the block of the current frame and the corresponding block of the background picture is greater than a threshold.

23. The apparatus of claim 16, wherein the processor is further configured to:
generate a block-level picture mask including a lighting value for each block, wherein a first lighting value is assigned to blocks of the current frame that include changes associated with the change in lighting, and wherein a second lighting value is assigned to blocks of the current frame that are not associated with the change in lighting.

24. The apparatus of claim 23, wherein the first value for a first block of the current frame indicates a difference between the first block and a corresponding first block of the background picture is caused by the change in lighting, and wherein the second value for a second block of the current frame indicates a difference between the second block and a corresponding second block of the background picture is not caused by the change in lighting.

25. The apparatus of claim 23, wherein the processor is further configured to:
convert the block-level picture mask to a pixel-level picture mask, wherein converting includes mapping a respective lighting value for each block to all pixels in each block;
obtain a foreground mask for the current frame;
compare the pixel-level picture mask to the foreground mask; and
determine whether one or more foreground pixels of the foreground mask are to be maintained as foreground pixels based on the comparison of the pixel-level picture mask to the foreground mask, wherein a foreground pixel of the foreground mask is maintained as the foreground pixel when the second lighting value is assigned to the foreground pixel in the pixel-level picture mask.

26. A computer readable medium having stored thereon instructions that when executed by a processor perform a method, including:
obtaining a current frame and a background picture;
detecting a frame-level lighting condition change for the current frame;
performing a block-level comparison of the current frame and the background picture when the frame-level lighting condition change is detected, the block-level comparison including comparing a block of pixels of the current frame with a corresponding block of pixels of the background picture, wherein a location of the block in the current frame is the same as a location of the corresponding block in the background picture; and
determining, based on the block-level comparison, that a change in the block of the current frame relative to a previous frame is associated with a change in lighting.

27. The computer readable medium of claim 26, further comprising:
obtaining a subsequent frame and an additional background picture, wherein the subsequent frame is obtained later in time than the current frame;
determining a frame-level lighting condition change is not present for the subsequent frame; and
performing a blob-level comparison of the subsequent frame and the additional background picture when the frame-level lighting condition change is determined not to be present for the subsequent frame, wherein a blob includes pixels of at least a portion of one or more foreground objects in a video frame.

28. The computer readable medium of claim 27, further comprising:
determining, based on the blob-level comparison, that a blob of the subsequent frame is associated with a change in lighting, wherein the blob includes pixels of at least a portion of a foreground object in the subsequent frame; and
determining the blob is a background blob based on determining the change in the blob is associated with the change in lighting.

29. The computer readable medium of claim 26, wherein detecting the frame-level lighting condition change for the current frame includes:
comparing a first histogram of the current frame to a second histogram of the background picture to determine a similarity between the first histogram and the second histogram; and
detecting the frame-level lighting condition change when the similarity between the first histogram and the second histogram is less than a similarity threshold.

30. The computer readable medium of claim 26, wherein determining, based on the block-level comparison, that the change in the block of the current frame is associated with the change in lighting includes:
determining a correlation between the block of the current frame and the corresponding block of the background picture is greater than a threshold.
